(19) United States
(12) Patent Application Publication
(10) Pub. No.: US 2013/0239023 A1
(43) Pub. Date: Sep. 12, 2013

(54) INFORMATION-PROCESSING DEVICE, COMMENT-PROMPTING METHOD, AND COMPUTER-READABLE RECORDING MEDIUM

(71) Applicants: Taku Konishi, Tokyo (JP); Daishi Kato, Tokyo (JP); Shinichi Doi, Tokyo (JP)

(72) Inventors: Taku Konishi, Tokyo (JP); Daishi Kato, Tokyo (JP); Shinichi Doi, Tokyo (JP)

(73) Assignee: NEC CORPORATION, Minato-ku, Tokyo (JP)

(21) Appl. No.: 13/881,650

(22) PCT Filed: Jul. 21, 2011
(86) PCT No.: PCT/JP2011/066567

§ 371 Date: Apr. 25, 2013

(30) Foreign Application Priority Data
Oct. 25, 2010 (JP) 2010-238242

(51) Int. Cl. H04L 29/08

(52) U.S. Cl. CPC H04L 67/22
USPC 715/753

(57) ABSTRACT

An information-processing device (201), comprises: an opinion information acquisition part (1) configured to acquire primary opinion information indicating each user's content of opinion with respect to one or more evaluation subjects; an opinion information selection part (2) configured to select one or more pieces of primary opinion information, as input-prompting information for the purpose of prompting a subject user to input content of opinion with respect to a presented evaluation subject which is a evaluation subject presented to subject user from among a plurality of pieces of primary opinion information acquired by opinion information acquisition part (1); and an opinion information presentation part (3) configured to present, to subject user, one or more pieces of primary opinion information selected by opinion information selection part (2).

### TECHNICAL FIELD

The present invention relates to an information-processing device, a comment-prompting method, and a computer readable recording medium, and in particular, relates to an information-processing device, comment-prompting method and computer readable recording medium for the purpose of prompting a user to input content of opinion with respect to an evaluation subject by presenting some sort of information to the user.

### BACKGROUND ART

Recent years, owing to dramatic progress of information communication environment such as Internet and a mobile phone, it has been possible to perform opinion-issuing widely without being subject to temporal and geographical constraints. For example, an opinion-issuing means such as Web vote and comment input on a homepage has propagated.

Then, in order to make an occasion for opinion-issuing like this prosperous, a system capable of acquiring an opinion from a larger number of people is expected.

As an example of a system which collects opinions from users, for example, in Japanese Patent Laid-Open No. 2006-293518 (Patent document 1), the following system has been disclosed. That is, a vote posting system comprises: an item list accumulation part storing an item list where items to be collected through voting are determined; a first information disclosure part configured to create a data-inputting screen having items of which selective input is possible and a posting column where descriptive input of arbitrary characters is possible based on the above-mentioned item list acquired from this item list accumulation part; an interface part configured to make the above-mentioned data-inputting screen displayed on a voter terminal via an electronic network, and at the same time, accept the data inputted on the above-mentioned data-inputting screen by the above-mentioned voter terminal; a storage part configured to store the accepted data; and an information analysis part configured to carry out grouping, for each item, of the data stored in this storage part.

### PRIOR ART DOCUMENT

### Patent Document

Patent Document 1: Japanese Patent Laid-Open No. 2006-293518

### SUMMARY OF THE INVENTION

### Problems to be Solved by the Invention

Meanwhile, for example, in many cases in a system for the purpose of collecting opinions with respect to a certain content, a few users input a comment positively with respect to this content among users who browse this content, and most users only browse this content and does not input comments. Consequently, a scheme capable of inducing a large number of users' comments is expected.

However, a configuration for the purpose of solving the problem such as this is not disclosed in Patent document 1.

This invention has been accomplished for solving the above-mentioned problem, and the object is to provide an information-processing device, comment-prompting method and computer readable recording medium which are capable of collecting opinions from a larger number of users.

### Means for Solving the Problems

For solving the problems mentioned above, an information-processing device according to an aspect of the present invention, comprising: an opinion information acquisition part configured to acquire primary opinion information indicating each user's content of opinion with respect to one or more evaluation subjects; an opinion information selection part configured to select one or more pieces of said primary opinion information, as input-prompting information for the purpose of prompting a subject user to input content of opinion with respect to a presented evaluation subject which is a evaluation subject presented to said subject user from among a plurality of pieces of said primary opinion information acquired by said opinion information acquisition part; and an opinion information presentation part configured to present, to said subject user, one or more pieces of said primary opinion information selected by said opinion information selection part.

For solving the problems mentioned above, a comment-prompting method according to an aspect of the present invention, comprising: a step to acquire primary opinion information indicating each user's content of opinion with respect to one or more evaluation subjects; a step to select one or more pieces of said primary opinion information, as input-prompting information for the purpose of prompting a subject user to input content of opinion with respect to a presented evaluation subject which is a evaluation subject presented to said subject user from among acquired two or more pieces of said primary opinion information; and a step to present selected one or more pieces of said primary opinion information to said subject user.

For solving the problems mentioned above, a computer readable recording medium according to an aspect of the present invention is the computer readable recording medium in which a comment-prompting program is recorded, said comment-prompting program being a program configured to make a computer execute the steps of: acquiring primary opinion information indicating each user's content of opinion with respect to one or more evaluation subjects; selecting one or more pieces of said primary opinion information, from among acquired two or more pieces of said primary opinion information, as input-prompting information for the purpose of prompting a subject user to input content of opinion with respect to a presented evaluation subject which is a evaluation subject presented to said subject user; and presenting selected one or more pieces of said primary opinion information to said subject user.

### Effect of the Invention

According to the present invention, opinions from a larger number of users can be collected.

### BRIEF DESCRIPTION OF THE DRAWINGS

FIG. 1 is a schematic configuration diagram of an information-processing device according to a first embodiment of the present invention;

FIG. 2 is a block diagram showing a control structure which a information-processing device according to the first embodiment of the present invention provides;

FIG. 3 is a figure showing an example of a comment-point table in the information-processing device according to the first embodiment of the present invention;

FIG. 4 is a figure showing an example of a textual characteristics-point table in the information-processing device according to the first embodiment of the present invention;

FIG. 5 is a figure showing an example of a textual characteristics-point table in the information-processing device according to the first embodiment of the present invention;

FIG. 6 is a figure showing an example of a textual characteristics-point table in the information-processing device according to the first embodiment of the present invention;

FIG. 7 is a figure showing an example of a textual characteristics-point table in the information-processing device according to the first embodiment of the present invention;

FIG. 8 is a figure showing an example of an emotional expression word list in the information-processing device according to the first embodiment of the present invention;

FIG. 9 is a figure showing an example of a textual characteristics-point table in the information-processing device according to the first embodiment of the present invention;

FIG. 10 is a figure showing an example of a comment point calculation table in the information-processing device according to the first embodiment of the present invention

FIG. 11 is a figure showing an example of a comment input standby-time table in the information-processing device according to the first embodiment of the present invention

FIG. 12 shows a flowchart indicating an operation procedure in the case where the information-processing device according to the first embodiment of the present invention performs comment-prompting processing;

FIG. 13 is a figure showing an example of a display screen for a user when the information-processing device according to the first embodiment of the present invention performs comment-prompting processing;

FIG. 14 is a figure showing an example of a display screen for a user when the information-processing device according to the first embodiment of the present invention performs comment-prompting processing;

FIG. 15 is a figure showing a frequency distribution of standby time until comment input with respect to a certain evaluation subject;

FIG. 16 is a block diagram showing a control structure which a information-processing device according to the first embodiment of the present invention provides;

FIG. 17 is a figure showing an example of the message list in the information-processing device according to the second embodiment of the present invention;

FIG. 18 is a flow chart indicating an operation procedure in the case where the information-processing device according to the second embodiment of the present invention performs comment-prompting processing;

FIG. 19 is a figure showing an example of a display screen for a user in the case where the information-processing device according to the second embodiment of the present invention performs comment-prompting processing;

FIG. 20 is a block diagram showing a control structure which a information-processing device according to the third embodiment of the present invention provides;

FIG. 21 is a figure showing an example of a user table in an information-processing device according to the third embodiment of the present invention;

FIG. 22 is a figure showing an example of an experience value calculation table in the information-processing device according to the third embodiment of the present invention;

FIG. 23 is a flow chart indicating an operation procedure in the case where the information-processing device according to the third embodiment of the present invention performs comment selection;

FIG. 24 is a figure showing other example of a frequency distribution of standby time until comment input with respect to a certain evaluation subject;

FIG. 25 is a figure showing an example of a comment-point table in the information-processing device according to the fourth embodiment of the present invention;

FIG. 26 is a flow chart indicating an operation procedure in the case where the information-processing device according to the fourth embodiment of the present invention performs comment selection;

FIG. 27 is a figure showing an example of a comment-expressivity table in the information-processing device according to the fifth embodiment of the present invention;

FIG. 28 is a figure showing an example of a positive/negative expression list in the information-processing device according to the fifth embodiment of the present invention

FIG. 29 is a flow chart indicating an operation procedure in the case where the information-processing device according to the fifth embodiment of the present invention performs comment selection;

FIG. 30 is a figure showing an example of a comment point calculation table in the information-processing device according to the sixth embodiment of the present invention;

### BEST MODES FOR CARRYING OUT THE INVENTION

Hereinafter, an embodiment of the present invention will be described using the figures. It is noted that the same reference character will be given to the same or corresponding part in the figures, and thus the description will not be repeated.

### First Embodiment

The information-processing device according to the first embodiment of the present invention, typically, includes a computer which has a general-purpose architecture as a basic structure, and provides various functions described later by executing a program installed in advance. Generally, a program like this circulates in a state of being stored in a recording medium such as a flexible disk (Flexible Disk) and a CD-ROM (Compact Disk Read Only Memory), or via a network, etc. In the case where a general-purpose computer like this is used, in addition to an application for providing functions according to the first embodiment of the present invention, an OS (Operating System) for providing a fundamental function of the computer may be installed. In this case, a program according to the first embodiment of the present invention may be what executes processing by calling a required module in a prescribed order and/or timing within program modules provided as a part of the OS. That is, a program itself according to the first embodiment of the present invention may not include above modules, and processing may be executed by collaborating with the OS. Therefore, as a program according to the first embodiment of the present invention, it may have a configuration which does not include modules as mentioned above.

Furthermore, a program according to the first embodiment of the present invention may be provided with being incorporated in a part of other programs such as an OS. Also in this case, a program itself according to the first embodiment of the present invention does not include modules which other programs of the incorporation destination have as mentioned above, and the processing is executed by collaborating with the other programs. That is, as a program according to the first embodiment of the present invention, it may have a configuration which is incorporated in other programs like this.

Besides, alternatively, apart or all of functions which are provided by the program execution may be implemented as dedicated hardware circuitry.

[Apparatus Configuration]

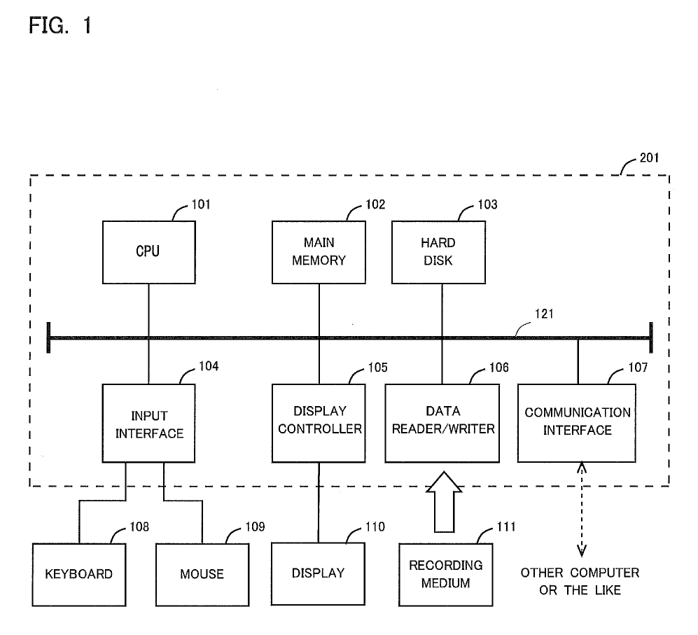

FIG. 1 is a schematic configuration diagram of an information-processing device according to the first embodiment of the present invention. With reference to FIG. 1, a information-processing device 201 is an information processing apparatus such as a portable information terminal, a personal computer and a server, and comprises: a CPU (Central Processing Unit) 101 which is an arithmetic processing unit; a main memory 102 and a hard disk 103; an input interface 104; a display controller 105; a data reader/writer 106; and a communication interface 107. Each of these parts is connected in a manner where data communication is possible mutually via a bus 121.

The CPU101 carried out various calculations by reading out programs (code) stored in the hard disk 103 and writing to the main memory 102, and executing these in prescribed order.

The main memory 102 typically is a volatile storage device such as a DRAM (Dynamic Random Access Memory), and holds data etc. which indicate various arithmetic processing results in addition to programs read from the hard disk 103. The hard disk 103 is nonvolatile magnetic storage device, and various setting values etc. are stored in addition to the programs executed by the CPU101. Programs installed on this hard disk 103 circulate in a state of being stored in a recording medium 111 as described later. Besides, in addition to the hard disk 103, or in place of the hard disk 103, a semiconductor memory such as a flash memory may be adopted.

The input interface 104 intermediates data transmission between the CPU101 and a keyboard 108, a mouse 109 and an input unit such as a touch panel which is not illustrated. That is, the input interface 104 accepts an input from the outside, such as operation command given by a user operating the input unit.

The display controller 105 is connected with a display 110 which is a typical example of a display unit, and controls display on the display 110. That is, the display controller 105 displays to a user a result or the like of image processing by the CPU101. The display 110 is a LCD (Liquid Crystal Display) or a CRT (Cathode Ray Tube), for example.

The data reader/writer 106 intermediates data transmission between the CPU101 and the recording medium 111. That is, the recording medium 111 circulates in a state where programs etc. executed by the information-processing device 201 is stored, and the data reader/writer 106 reads the programs from this recording medium 111.

The data reader/writer 106, in response to an internal command of the CPU101, writes a processing result, etc. in the information-processing device 201 to the recording medium 111. Besides, the recording medium 111 is, for example, a general-purpose semiconductor storage device such as a CF (Compact Flash) and a SD (Secure Digital), a magnetic storage medium such as a flexible disk (Flexible Disk), or an optical storage medium such as a CD-ROM (Compact Disk Read Only Memory).

The communication interface 107 intermediates data transmission between the CPU101 and a personal computer, a server device or the like. The communication interface 107, typically, has a communication function of Ethernet® or a USB (Universal Serial Bus). Besides, in place of a configuration where programs stored in the recording medium 111 are installed on the information-processing device 201, programs downloaded from a distribution server etc. via the communication interface 107 may be installed on the information-processing device 201.

To the information-processing device 201, other output apparatuses, such as a printer, may be connected as necessary.

[Control Structure]

Then, a control structure for providing various functions in an information-processing device 201 according to the first embodiment of the present invention will be described.

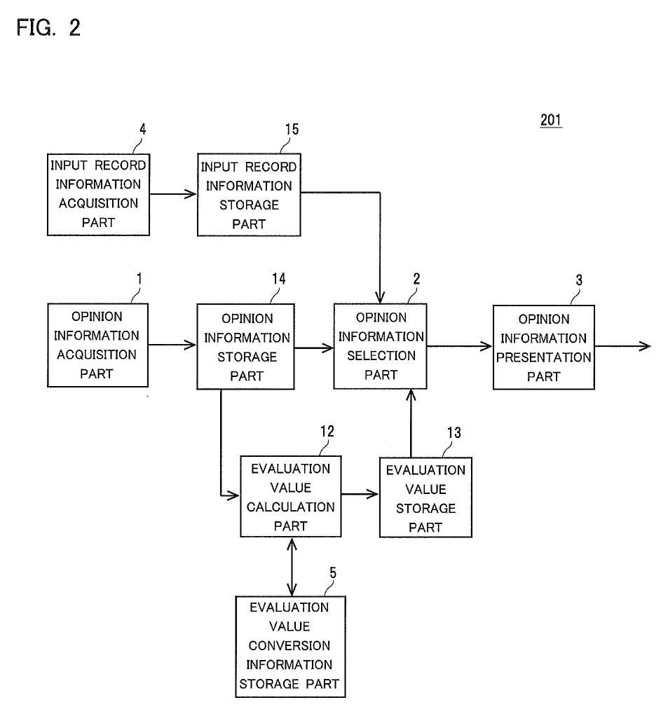

FIG. 2 is a block diagram showing a control structure which an information-processing device according to the first embodiment of the present invention provides.

Each block of the information-processing device 201 shown in FIG. 2 is provided by reading out programs (code) etc. stored in the hard disk 103 and writing to the main memory 102, and making the CPU101 execute them. Besides, a part or all of modules shown in FIG. 2 may be provided by a firmware implemented in hardware. Alternatively, a part or all of control structures shown in FIG. 2 may be realized by dedicated hardware and/or a wiring circuit.

With reference to FIG. 2, an information-processing device 201 comprises as a control structure thereof: an opinion information acquisition part 1; an opinion information selection part 2; an opinion information presentation part 3; an input record information acquisition part 4; an evaluation value conversion information storage part 5; an evaluation value calculation part 12; an evaluation value storage part 13; an opinion information storage part 14; and an input record information storage part 15. The evaluation value conversion information storage part 5, evaluation value storage part 13, opinion information storage part 14, and input recorded information storage part 15 correspond to a main memory 102 or hard disk 103 shown in FIG. 1, for example. The opinion information presentation part 3 outputs input-prompting information to the hard disk 103 or display 110 shown in FIG. 1 for example.

CPU101 is generally constituted of many units other than each part shown in FIG. 2, and however, other units are not illustrated for simplicity of description.

The opinion information acquisition part 1 acquires a comment (primary opinion information) which indicates each user's content of opinion with respect to one or more evaluation subjects, and stores it in the opinion information storage part 14.

Here, the evaluation subject means all the matters which can be subjects of opinion-issuing. For example, in evaluation subjects, included are an agenda such as a policy, a measure, law, a bill, a rule, an incident, and a news article; a good such as food and a product; service such as service in stores, service in facilities, and service of Web contents; a copyrighted work such as literature, music, a picture, a sculpture, a movie, a theater, and a building; and an opinion and idea of others.

The opinion information selection part 2, as the input-prompting information for the purpose of prompting a subject user to input a comment with respect to a presented evaluation subject which is an evaluation subject that is presented to the subject user, selects one or more comments from among a plurality of comments acquired by the opinion information acquisition part 1.

The opinion information presentation part 3 presents to the subject user one or more comments selected by the opinion information selection part 2.

In more details, the evaluation value conversion information storage part 5 stores a correspondence relation between textual information characteristics and an evaluation value, for example.

The evaluation value calculation part 12, based on the correspondence relation stored by the evaluation value conversion information storage part 5, converts a content of the comment acquired by the opinion information acquisition part 1 into an evaluation value, and stores information indicating a correspondence relation between the comment and the evaluation value in the evaluation value storage part 13.

The opinion information selection part 2, with reference to the information stored in the evaluation value storage part 13, selects one or more comments based on the evaluation value converted by the evaluation value calculation part 12.

In addition, the input record information acquisition part 4 acquires input record information indicating a record in which each user has inputted a comment with respect to one or more evaluation subjects, and stores it in the input record information storage part 15.

For example, the opinion information selection part 2 selects one or more comments based on the input record information acquired by the input record information acquisition part 4.

In more details, the evaluation value conversion information storage part 5 stores a correspondence relation between an input record of a comment by a user and an evaluation value, for example.

The evaluation value calculation part 12, based on the correspondence relation stored by the evaluation value conversion information storage part 5, converts the input record information corresponding to the comment acquired by the opinion information acquisition part 1 into an evaluation value, and stores information indicating a correspondence relation between the comment and the evaluation value in the evaluation value storage part 13.

The opinion information selection part 2, with reference to the information stored in the evaluation value storage part 13, selects one or more comments based on the evaluation value converted by the evaluation value calculation part 12.

[Operation]

Then, an operation of a information-processing device according to the first embodiment of the present invention will be described using the figures In the first embodiment of the present invention, a comment-prompting method according to a first embodiment of the present invention is performed by making the information-processing device 201 operate. Therefore, a description of the comment-prompting method according to the first embodiment of the present invention is substituted by an operation description of the following information-processing device 201. In the following description, FIG. 2 is referred to suitably.

[Selection Method of Comment]

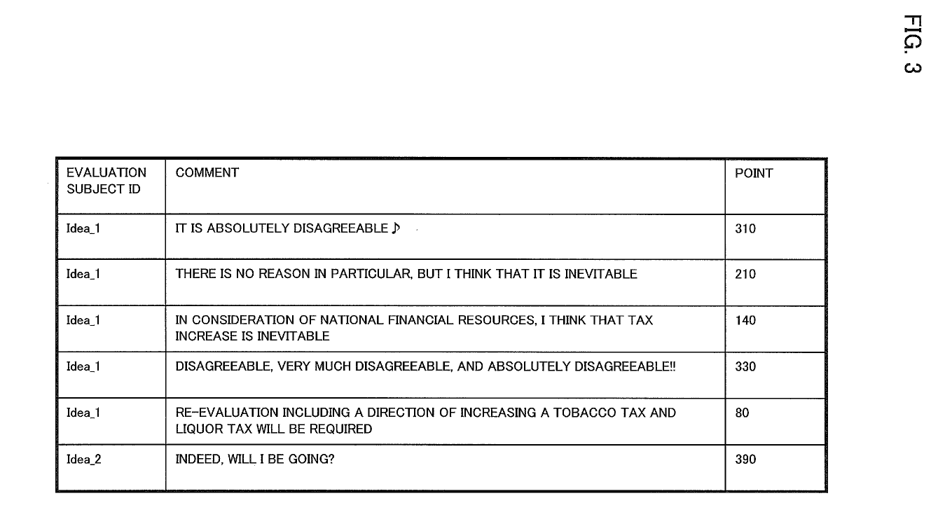

FIG. 3 is a figure showing an example of a comment-point table in the information-processing device according to the first embodiment of the present invention.

With reference to FIG. 3, the comment-point table is the table indicating a correspondence relation between a comment which is primary opinion information indicating each user's content of opinion with respect to each evaluation subject and a point (evaluation value) of this comment. The evaluation value storage part 13 stores this comment-point table.

The opinion information selection part 2, with reference to the comment-point table stored in the evaluation value storage part 13, selects a comment based on a point of each comment.

In this comment-point table, a comment with respect to an evaluation subject of which evaluation subject ID (Identifier) is Idea_{—}1 and an evaluation subject of which evaluation subject ID is Idea_{—}2, as well as a point for each comment, are shown.

For example, an evaluation subject of which evaluation subject ID is Idea_{—}1 is a question ┌ [symbol] [symbol] ┘ (“What do you think about tax increase?”), and with respect to this question, the answers are as follow: the point of the comment ┌ [symbol] [symbol] ┘ (“it is absolutely disagreeable [symbol] ”) is 310; the point of the comment ┌ [symbol] [symbol] [symbol] ┘ (“There is no reason in particular, but I think that it is inevitable”) is 210; the point of the comment ┌ [symbol] [symbol] [symbol] ┘ (“In consideration of national financial resources, I think that tax increase is unavoidable”) is 140; the point of the comment ┌ [symbol] [symbol] !″┘ (“Disagreeable, very much disagreeable, and absolutely disagreeable!!”) is 330; and the point of the comment └ [symbol] [symbol] [symbol] ┘ (“Re-evaluation including a direction of increasing a tobacco tax and liquor tax will be required”) is 80.

In addition, an evaluation subject of which evaluation subject ID is Idea_{—}2 is information with respect to a certain event, and with respect to this information, the point of the comment ┌ [symbol] ┘ (“Indeed, will I be going?”) is 390.

In addition, the evaluation value conversion information storage part 5 stores a textual characteristics-point table indicating a correspondence relation between textual information characteristics and an evaluation value. In this textual characteristics-point table, a plurality of ranges with respect to a degree of textual information characteristics are provided, and an evaluation value for the every range is registered, for example.

The evaluation value calculation part 12, with reference to the textual characteristics-point table, analyzes comments which are acquired by the opinion information acquisition part 1 and stored in the opinion information storage part 14, and calculates a point of this comment. Then, the evaluation value calculation part 12 registers the comment newly analyzed and a point thereof into the comment-point table.

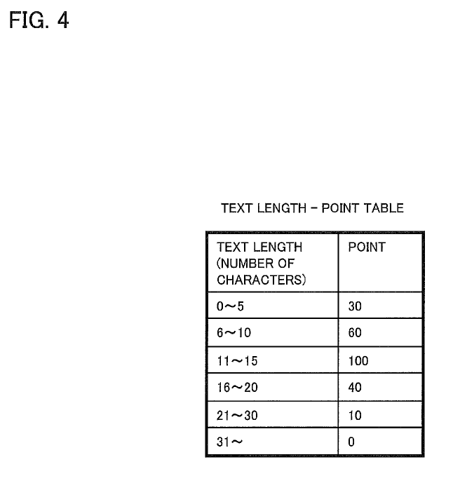

FIG. 4 is a figure showing an example of a textual characteristics-point table in the information-processing device according to the first embodiment of the present invention.

With reference to FIG. 4, this textual characteristics-point table is the table indicating a correspondence relation between a text length, i.e., the number of characters and a point.

This textual characteristics-point table shows that: the point of the comment of which the number of characters is between 0 and 5 is 30; the point of the comment of which the number of characters is between 6 and 10 is 60; the point of the comment of which the number of characters is between 11 and 15 is 100; the point of the comment of which the number of characters is between 16 and 20 is 40; the point of the comment of which the number of characters is between 21 and 30 is 10; and the point of the comment of which the number of characters is no less than 31 is 0.

That is, the evaluation value conversion information storage part 5 stores a correspondence relation in which the nearer the number of characters of a comment approaches to a prescribed value that is 11 to 15 here, the larger an evaluation value is. In more details, the evaluation value conversion information storage part 5 stores a correspondence relation in which at least a first range, a second range and a third range in ascending order with respect to the number of characters of a comment is provided, and the evaluation value of the second range is larger than that of the first range and the third range.

By such a configuration as this, an appropriate evaluation value can be given to each comment. That is, an evaluation value having a too short comment is made to be lowered, and thereby, it is possible to prompt a user to input an appropriate comment. In addition, an evaluation value having a too long comment is made to be lowered, and thereby, a mental threshold with respect to user's comment input can be lowered.

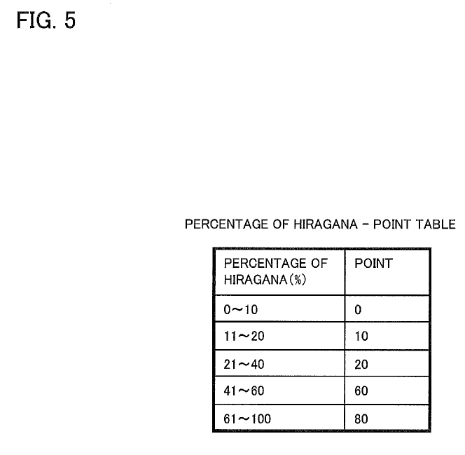

FIG. 5 is a figure showing an example of a textual characteristics-point table in the information-processing device according to the first embodiment of the present invention.

With reference to FIG. 5, this textual characteristics-point table is the table indicating a correspondence relation between a percentage of Hiragana and a point.

This textual characteristics-point table shows that: the point of the comment in which a percentage of Hiragana is 0% to 10% is 0; the point of the comment in which a percentage of Hiragana is 11% to 20% is 10; the point of the comment in which a percentage of Hiragana is 21% to 40% is 20; the point of the comment in which a percentage of Hiragana is 41% to 60% is 60; and the point of the comment in which a percentage of Hiragana is 61% to 100% is 80.

That is, the evaluation value conversion information storage part 5 stores a correspondence relation in which the nearer the content percentage of Hiragana in a comment approaches to a prescribed value that is 61% to 15% here, the larger an evaluation value is. In more details, the evaluation value conversion information storage part 5 stores a correspondence relation in which the larger the content percentage of Hiragana in a comment is, the larger an evaluation value is.

In this way, an evaluation value of a comment in which a percentage of Hiragana is small is made to be lowered, and an evaluation value of a comment in which a percentage of Hiragana is larger is made to be risen, and thereby, an appropriate evaluation value can be given to each comment. For example, it becomes possible to present a comment in which an evaluation value is high in the case where a mental threshold with respect to user's comment input is made to be lowered, and to present a comment in which an evaluation value is low in the case of prompting a user to input an advanced comment.

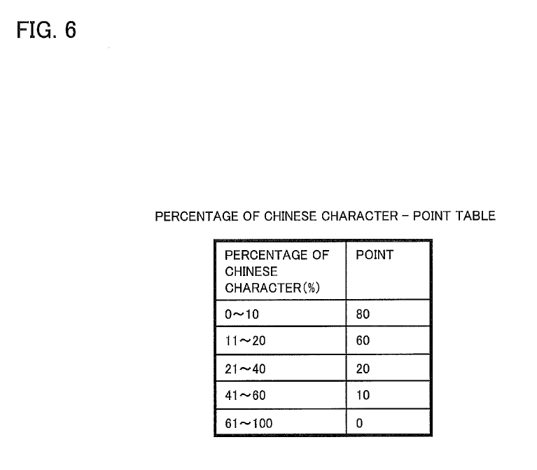

FIG. 6 is a figure showing an example of a textual characteristics-point table in the information-processing device according to the first embodiment of the present invention.

With reference to FIG. 6, this textual characteristics-point table is the table indicating a correspondence relation between a percentage of Chinese character and a point.

This textual characteristics-point table shows that: the point of the comment in which a percentage of Chinese character is 0% to 10% is 80; the point of the comment in which a percentage of Chinese character is 11% to 20% is 60; the point of the comment in which a percentage of Chinese character is 21% to 40% is 20; the point of the comment in which a percentage of Chinese character is 41% to 60% is 10; and the point of the comment in which a percentage of Chinese character is 61% to 100% is 0.

That is, the evaluation value conversion information storage part 5 stores a correspondence relation in which the nearer the percentage of Chinese character in a comment approaches to a prescribed value that is 61% to 100% here, the larger an evaluation value is. In more details, the evaluation value conversion information storage part 5 stores a correspondence relation in which the larger the content percentage of Chinese character in a comment is, the smaller an evaluation value is.

In this way, an evaluation value of a comment in which a percentage of Chinese character is small is made to be lowered, and an evaluation value of a comment in which a percentage of Chinese character is larger is made to be risen, and thereby, an appropriate evaluation value can be given to each comment. For example, it becomes possible to present a comment in which an evaluation value is high in the case where a mental threshold with respect to user's comment input is made to be lowered, and to present a comment in which an evaluation value is low in the case of prompting a user to input an advanced comment.

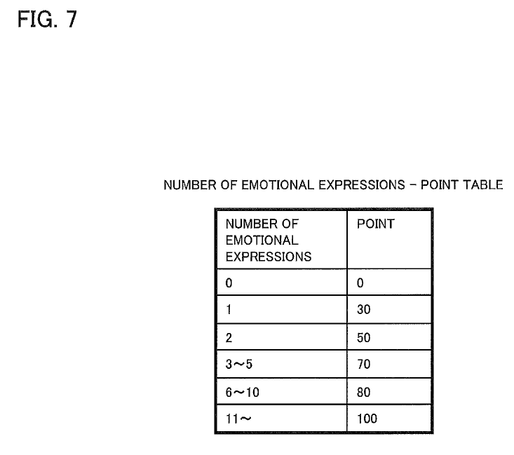

FIG. 7 is a figure showing an example of a textual characteristics-point table in the information-processing device according to the first embodiment of the present invention.

With reference to FIG. 7, this textual characteristics-point table is the table indicating a correspondence relation between the number of emotional expressions, i.e., the number of emotional expression words and a point.

This textual characteristics-point table shows that: the point of the comment in which the number of emotional expressions is 0 is 0; the point of the comment in which the number of emotional expressions is 1 is 30; the point of the comment in which the number of emotional expressions is 2 is 50; the point of the comment in which the number of emotional expressions is 3 to 5 is 70; the point of the comment in which the number of emotional expressions is 6 to 10 is 80; and the point of the comment in which the number of emotional expressions is no less than 11 is 100.

That is, the evaluation value conversion information storage part 5 stores a correspondence relation in which the nearer the number of emotional expressions in a comment approaches to a range of a prescribed value that is no more than 11 here, the larger an evaluation value is. In more details, the evaluation value conversion information storage part 5 stores a correspondence relation in which the larger the number of emotional expression words or emotional expression symbols in a comment is, the larger an evaluation value is. In this way, an evaluation value of a comment in which the number of emotional expressions is large is made to be risen, and an evaluation value of a comment in which the number of emotional expressions is small is made to be lowered, and thereby, an appropriate evaluation value can be given to each comment. That is, since the more a comment has the number of emotional expressions, the larger a mental influence on a user becomes, it becomes possible to prompt a user to input a comment.

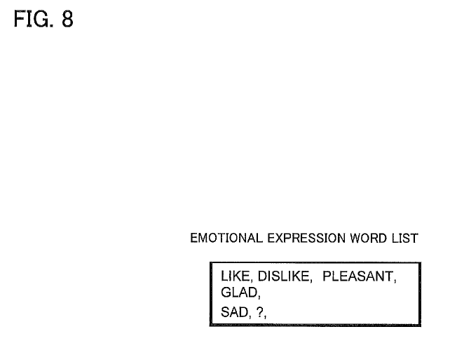

FIG. 8 is a figure showing an example of an emotional expression word list in the information-processing device according to the first embodiment of the present invention.

With reference to FIG. 8, this emotional expression word list includes, as an emotional expression words, ┌ [symbol] [symbol] ┘ (“like”), ┌ [symbol] ┘ (“dislike”), ┌ [symbol] ┘ (“pleasant”), ┌ [symbol] ┘ (“glad”), ┌ [symbol] ┘ (“sad”), ┌ [symbol] ┘ (“interesting”), ┌ [symbol] ┘ (“disagreeable”), and “?”, for example.

The evaluation value conversion information storage part 5 stores this emotional expression word list. The evaluation value calculation part 12, with reference to the emotional expression word list stored in the evaluation value conversion information storage part 5, counts the number of emotional expressions in a comment acquired by the opinion information acquisition part 1, and furthermore, with reference to the number of emotional expressions-point table stored in the evaluation value conversion information storage part 5, calculates a point of this comment.

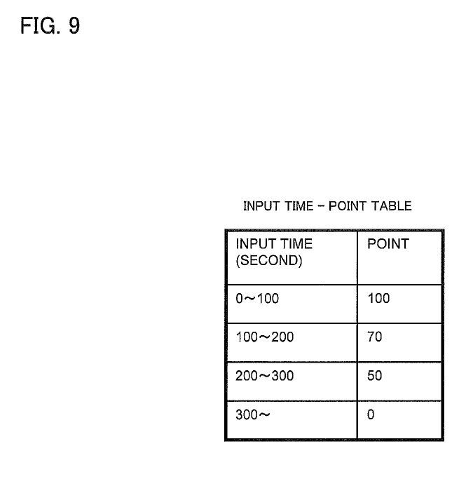

FIG. 9 is a figure showing an example of a textual characteristics-point table in the information-processing device according to the first embodiment of the present invention.

With reference to FIG. 9, this textual characteristics-point table is the table indicating a correspondence relation between input time of a comment by a user and a point.

This textual characteristics-point table shows that: the point of the comment in which input time is 0 second to 100 seconds is 100; the point of the comment in which input time is 100 seconds to 200 seconds is 70; the point of the comment in which input time is 200 seconds to 300 seconds is 50; and the point of the comment in which input time is no less than 300 seconds is 0.

That is, the evaluation value conversion information storage part 5 stores a correspondence relation in which the shorter the input time of a comment by a user is, the larger an evaluation value is.

In this way, an evaluation value of a comment in which input time is short is made to be risen, and an evaluation value of a comment in which input time is long is made to be lowered, and thereby, an appropriate evaluation value can be given to each comment. That is, since the shorter the input time of a comment is, the easier the comment is for a user to input, and the longer the input time of a comment is, the more difficult the comment is for a user to input, it becomes possible to present a comment in which a evaluation value is high in the case where a mental threshold with respect to user's comment input is made to be lowered, and to present a comment in which a evaluation value is low in the case of prompting a user to input an advanced comment, for example.

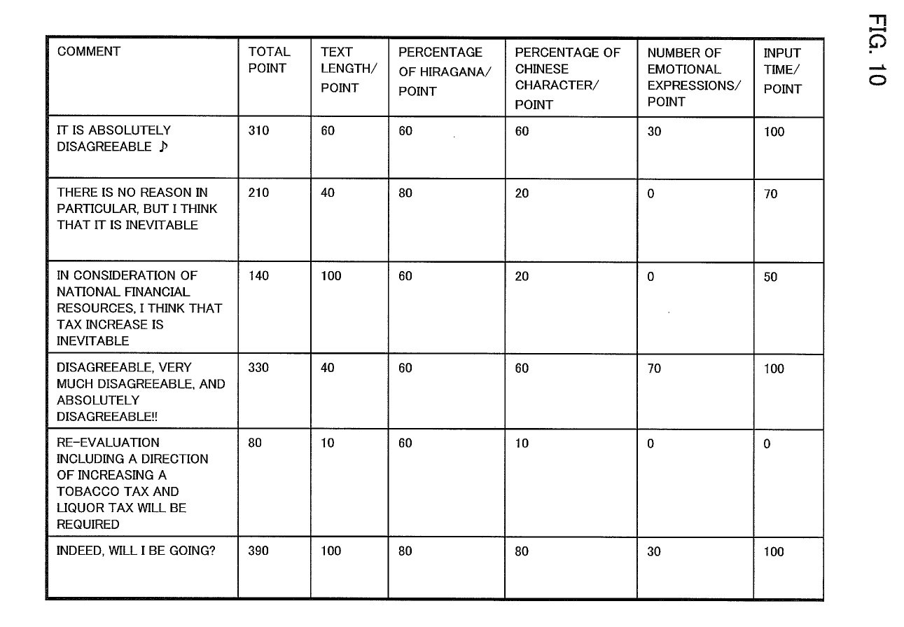

FIG. 10 is a figure showing an example of a comment point calculation table in the information-processing device according to the first embodiment of the present invention.

With reference to FIG. 10, the comment point calculation table is the table which indicates a point for every textual characteristic which each comment has, and indicating a total value thereof.

This comment point calculation table is created by the evaluation value calculation part 12 based on above-mentioned each textual characteristics-point table, and is stored in the evaluation value conversion information storage part 5.

Specifically, with respect to the comment ┌ [symbol] [symbol] ┘ (“It is absolutely disagreeable [symbol] ”), this comment point calculation table shows that: the point with respect to the text length is 60; the point with respect to the percentage of Hiragana is 60; the point with respect to the percentage of Chinese character is 60; the point with respect to the number of emotional expressions is 30; the point with respect to the input time is 100; and the total point is 310.

In addition, with respect to the comment ┌ [symbol] [symbol] [symbol] ┘ (“There is no reason in particular, but I think that it is inevitable”), the table shows that: the point with respect to the text length is 40; the point with respect to the percentage of Hiragana is 80; the point with respect to the percentage of Chinese character is 20; the point with respect to the number of emotional expressions is 0; the point with respect to the input time is 70; and the total point is 210.

In addition, with respect to the comment ┌ [symbol] [symbol] [symbol] [symbol] ┘ (“In consideration of national financial resources, I think that tax increase is inevitable”), the table shows that: the point with respect to the text length is 100; the point with respect to the percentage of Hiragana is 60; the point with respect to the percentage of Chinese character is 20; the point with respect to the number of emotional expressions is 0; the point with respect to the input time is 50; and the total point is 140.

In addition, with respect to the comment ┌ [symbol] [symbol] !!┘ (“Disagreeable, very much disagreeable, and absolutely disagreeable!!”), the table shows that: the point with respect to the text length is 40; the point with respect to the percentage of Hiragana is 60; the point with respect to the percentage of Chinese character is 60; the point with respect to the number of emotional expressions is 70; the point with respect to the input time is 100; and the total point is 330.

In addition, with respect to the comment ┌ [symbol] [symbol] [symbol] [symbol] _{∘}┘ (“Re-evaluation including a direction of increasing a tobacco tax and liquor tax will be required”), the table shows that: the point with respect to the text length is 10; the point with respect to the percentage of Hiragana is 60; the point with respect to the percentage of Chinese character is 10; the point with respect to the number of emotional expressions is 0; the point with respect to the input time is 0; and the total point is 80.

In addition, with respect to the comment ┌ [symbol] [symbol] ┘ (“Indeed, will I be going ?”), the table shows that: the point with respect to the text length is 100; the point with respect to the percentage of Hiragana is 80; the point with respect to the percentage of Chinese character is 80; the point with respect to the number of emotional expressions is 30; the point with respect to the input time is 100; and the total point is 390.

The evaluation value calculation part 12 creates the comment-point table shown in FIG. 3 with reference to the comment point calculation table stored in the evaluation value conversion information storage part 5, and stores it in the evaluation value storage part 13.

[Comment Presenting Method (Part 1)]

Next, presenting operation of a comment by the information-processing device according to the first embodiment of the present invention will be described using drawings.

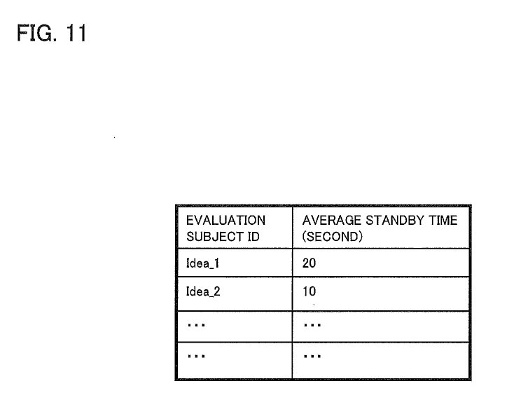

FIG. 11 is a figure showing an example of a comment input standby-time table in the information-processing device according to the first embodiment of the present invention.

With reference to FIG. 11, the comment input standby-time table, with respect to each evaluation subject, stores an average value of standby time after a plurality of users start browsing of the evaluation subject until they input a comment.

The input record information acquisition part 4 acquires the input record information indicating a record in which each user has inputted a comment with respect to a presented evaluation subject.

In more details, the input record information acquisition part 4 acquires standby time after a prescribed timing until each user starts inputting of a comment with respect to each evaluation subject.

For example, the input record information acquisition part 4 acquires standby time after each user starts browsing of each evaluation subject until each user inputs a comment. Then, the input record information acquisition part 4, by calculating an average value of the standby time for every evaluation subject, acquires the average standby time to create a comment input standby-time table, and stores it in the input record information storage part 15.

The opinion information selection part 2, based on the input record information acquired by the input record information acquisition part 4, that is, the comment input standby-time table, determines presenting methods for one or more comments selected by the opinion information selection part 2, that is a comment presenting timing, for example.

Specifically, the opinion information presentation part 3, in the case where a comment with respect to the presented evaluation subject is not inputted even if prescribed time elapses after the prescribed timing, presents a comment to a subject user.

The opinion information selection part 2, with reference to the comment input standby-time table, calculates the above-mentioned prescribed time based on each standby time with respect to the presented evaluation subject. For example, the opinion information selection part 2 calculates mean time of each standby time with respect to the presented evaluation subject, and calculates time shorter than the calculated mean time as the above-mentioned prescribed time.

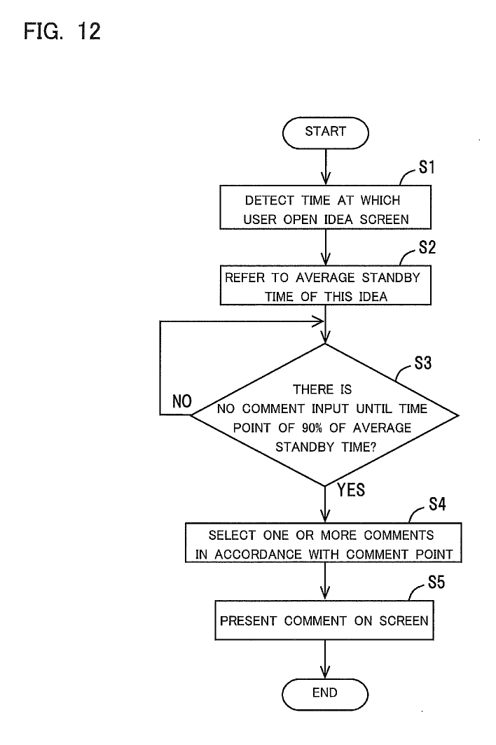

FIG. 12 shows a flow chart indicating an operation procedure in the case where the information-processing device according to the first embodiment of the present invention performs comment-prompting processing.

With reference to FIG. 12, first, the opinion information selection part 2 detects a timing at which a user starts browsing of an evaluation subject, for example, a time at which the user opens a screen with an idea displayed (Step S1).

Next, the opinion information selection part 2, with reference to the comment input standby-time table stored in the input record information storage part 15, acquires average standby time of this evaluation subject (Step S2).

Next, the opinion information selection part 2 stands by after the timing at which a user has started browsing of an evaluation subject until 90% of the average standby time of this evaluation subject for example elapses (NO at Step S3).

Then, the opinion information selection part 2, in the case where the user does not input a comment with respect to this evaluation subject even if up to 90% of the average standby time of this evaluation subject elapses after the timing at which a user has started browsing of the evaluation subject (YES at Step S3), with reference to the comment-point table stored in the evaluation value storage part 13, selects one or more comments based on a point which each comment has, and outputs them to the opinion information presentation part 3 (Step S4).

Next, the opinion information presentation part 3 presents to a user the comment received from the opinion information selection part 2 (Step S5).

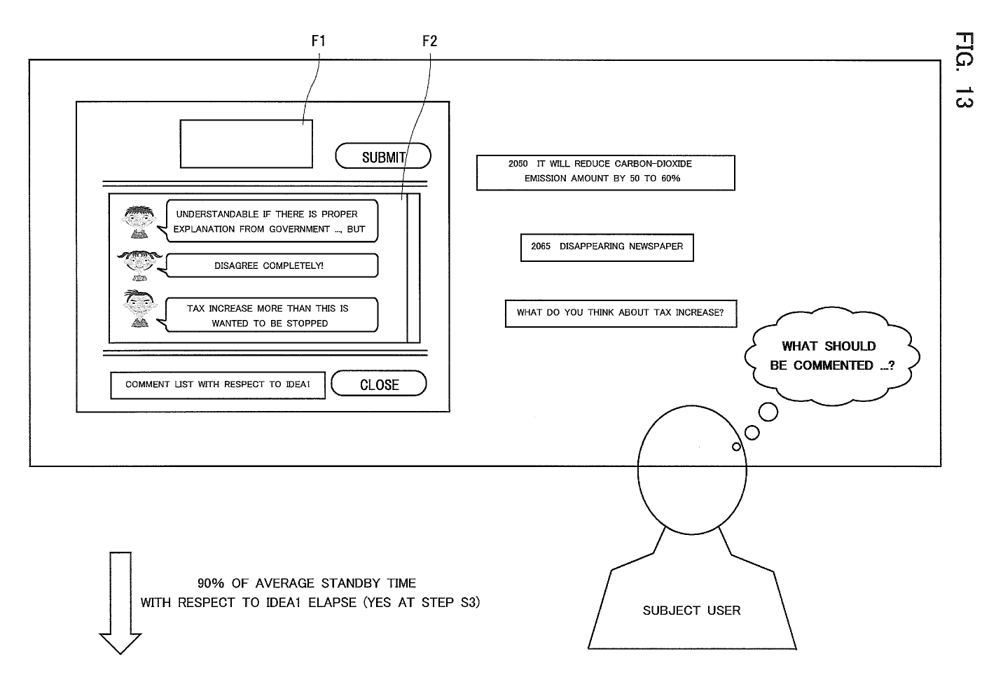

FIG. 13 is a figure showing an example of a display screen for a user when the information-processing device according to the first embodiment of the present invention performs comment-prompting processing.

With reference to FIG. 13, a comment input screen with respect to an evaluation subject of which evaluation subject ID is Idea_{—}1 is displayed on this screen. Here, as an evaluation subject of Idea_{—}1, a question “What do you think about tax increase?” is displayed.

First, the opinion information presentation part 3 display an input field F1 for a user to input a comment and a past comment field F2 in which each comment stored in the opinion information storage part 14 is arranged in the order in which the comment has been acquired by the opinion information acquisition part 1, for example. In the past comment field F2, a scroll bar is provided and a user can browse all the comments stored in the opinion information storage part 14.

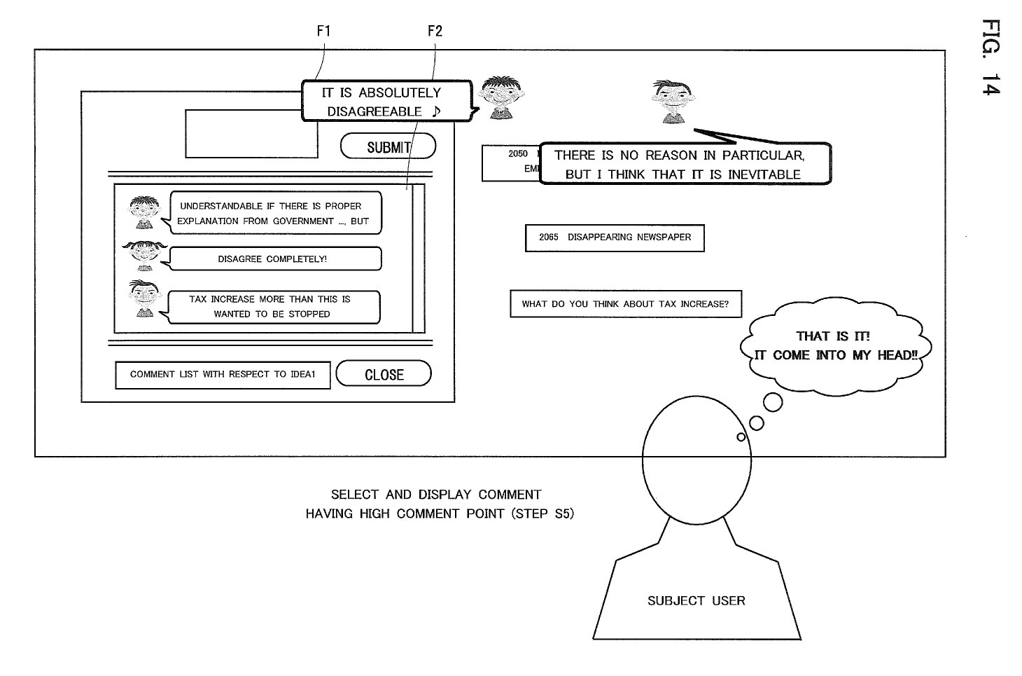

Then, the opinion information selection part 2, in the case where even if 90% for example of the average standby time corresponding to the evaluation subject elapses after this screen has been displayed, a user does not think of a comment, and a comment with respect to this evaluation subject is not inputted (YES at Step S3), displays a screen as shown in FIG. 14 in the following by outputting one or more comments to the opinion information presentation part (Step S4).

FIG. 14 is a figure showing an example of a display screen for a user when the information-processing device according to the first embodiment of the present invention performs comment-prompting processing.

With reference to FIG. 14, the opinion information presentation part 3, for example, display on a screen the comment “It is absolutely disagreeable [symbol] ” and the comment “There is no reason in particular, but I think that it is inevitable” which are comments having a high point (Step S5).

Looking at such comments, a user thinks of a comment with respect to the evaluation subject, and inputs this comment.

[Comment Presenting Method (Part 2)]

Next, other examples of presenting operation of a comment by the information-processing device according to the first embodiment of the present invention will be described using drawings.

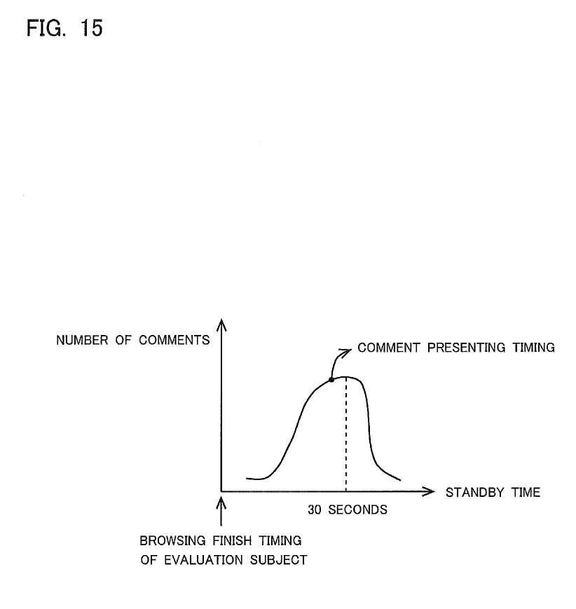

FIG. 15 is a figure showing a frequency distribution of standby time until comment input with respect to a certain evaluation subject.

With reference to FIG. 15, the input record information acquisition part 4 acquires standby time after each user finishes browsing of each evaluation subject until each user inputs a comment, and stores it in the input record information storage part 15.

The opinion information selection part 2 creates, for every evaluation subject, a frequency distribution of each standby time stored in the input record information storage part 2.

The opinion information selection part 2 creates a frequency distribution of each standby time acquired by the input record information acquisition part 4, and detects a peak in the created frequency distribution, and calculates time shorter than the standby time corresponding to the detected peak as a comment presenting timing.

Specifically, the opinion information selection part 2, since the most users have inputted a comment after seconds from a browsing finish time of a certain evaluation subject, presents a comment at the timing a little before the 30 seconds which is the peaking time.

That is, the opinion information selection part 2, in place of average standby time in Step S3 of the flowchart shown in FIG. 12, configures the timing a little before the peaking time in the created frequency distribution.

Meanwhile, in many cases in a system for the purpose of collecting opinions with respect to a certain content, a few users input a comment positively with respect to this content among users who browse this content, and most users only browse this content and does not input comments. Consequently, a scheme capable of inducing a large number of users' comments is expected.

As compared with this, in the information-processing device according to the first embodiment of the present invention, the opinion information acquisition part 1 acquires primary opinion information which indicates each user's content of opinion with respect to one or more evaluation subjects. The opinion information selection part 2, as input-prompting information for the purpose of prompting a subject user to input content of opinion with respect to a presented evaluation subject which is a evaluation subject presented to a subject user, selects one or more pieces of primary opinion information from among a plurality of pieces of primary opinion information acquired by the opinion information acquisition part 1. Then, the opinion information presentation part 3 presents, to a subject user, one or more pieces of primary opinion information selected by the opinion information selection part 2.

In this way, by selecting and presenting past comments of other users or subject users to the subject user who is browsing an evaluation subject, it is possible to prompt the subject user to input a comment with respect to an evaluation subject effectively.

That is, by a minimum configuration comprised of the opinion information acquisition part 1, the opinion information selection part 2, and the opinion information presentation part 3 among each constituent in the information-processing device according to the first embodiment of the present invention, it becomes possible to achieve an object of the present invention to collect opinions from a larger number of users.

In addition, in the information-processing device according to the first embodiment of the present invention, primary opinion information is textual information, and the evaluation value conversion information storage part 5 stores a correspondence relation between the textual information characteristics and the evaluation value. The evaluation value calculation part 12, based on the correspondence relation stored by the evaluation value conversion information storage part 5, converts the content of opinion which the primary opinion information acquired by the opinion information acquisition part 1 indicates into an evaluation value. Then, the opinion information selection part 2 selects one or more pieces of primary opinion information based on the evaluation value which has been converted by the evaluation value calculation part 12.

By such a configuration as this, it becomes possible to calculate an evaluation value of each comment based on textual information characteristics, and select a comment appropriately based on this evaluation value.

In addition, in the information-processing device according to the first embodiment of the present invention, the evaluation value conversion information storage part 5 is provided with a plurality of ranges with respect to a degree of textual information characteristics, and stores a correspondence relation indicating an evaluation value for the every range.

By such a configuration as this, as compared with a configuration which makes an evaluation value increase or decrease in proportion to a degree of a textual information characteristics for example, it becomes possible to perform configuring of an evaluation value more flexibly such as making the evaluation value as a constant value in the case where the degree of the textual information characteristics exceeds a certain range.

In addition, in the information-processing device according to the first embodiment of the present invention, the input record information acquisition part 4 acquires input record information indicating a record where each user has inputted content of opinion with respect to one or more evaluation subjects. Then, the opinion information selection part 2 selects one or more pieces of primary opinion information based on the input record information acquired by the input record information acquisition part 4.

By such a configuration as this, it becomes possible to select a comment appropriately based on an input record of each comment.

In addition, in the information-processing device according to the first embodiment of the present invention, the evaluation value conversion information storage part 5 stores a correspondence relation between an input record of content of opinion by a user and an evaluation value. The evaluation value calculation part 12, based on the correspondence relation stored by the evaluation value conversion information storage part 5, converts the input record information corresponding to the primary opinion information acquired by the opinion information acquisition part 1 into an evaluation value. Then, the opinion information selection part 2 selects one or more pieces of primary opinion information based on the evaluation value which has been converted by the evaluation value calculation part 12.

By such a configuration as this, it becomes possible to calculate an evaluation value of each comment based on an input record of each comment, and select a comment appropriately based on this evaluation value.

In addition, in the information-processing device according to the first embodiment of the present invention, the input record information acquisition part 4 acquires input record information indicating a record where each user has inputted content of opinion with respect to presented one or more evaluation subjects. Then, the opinion information selection part 2, based on the input record information acquired by the input record information acquisition part 4, determines a presenting method of one or more selected pieces of primary opinion information.

In this way, by a configuration determining an appropriate presenting method of a comment using each user's comment input record, it is possible to prompt still more a subject user to input a comment with respect to an evaluation subject.

In addition, in the information-processing device according to the first embodiment of the present invention, the opinion information selection part 2, based on the input record information acquired by the input record information acquisition part 4, determines a presenting timing of one or more selected pieces of primary opinion information.

By such a configuration as this, since a comment can be presented to a user in an appropriate timing, it is possible to prompt still more a subject user to input a comment with respect to an evaluation subject.

In addition, in the information-processing device according to the first embodiment of the present invention, in the case where content of opinion with respect to the presented evaluation subject is not inputted even if a prescribed time has elapsed after the prescribed timing, the opinion information selection part 2 presents input-prompting information to a subject user.

By such a configuration as this, since it is possible to present a comment at an appropriate timing to a user who has not performed comment input, it is possible to prompt still more a subject user to input a comment with respect to an evaluation subject.

In addition, in the information-processing device according to the first embodiment of the present invention, the input record information acquisition part 4 acquires standby time after a prescribed timing until each user starts inputting of content of opinion with respect to a presented evaluation subject. Then, the opinion information selection part 2 calculates the above-mentioned prescribed time based on each standby time acquired by the input record information acquisition part 4.

By such a configuration as this, it is possible to acquire an appropriate presenting timing using each user's standby time.

In addition, in the information-processing device according to the first embodiment of the present invention, the opinion information selection part 2 calculates mean time of each standby time acquired by the input record information acquisition part 4, and calculates the time shorter than the calculated mean time as the above-mentioned prescribed time.

In this way, since it is possible to acquire an appropriate presenting timing from an average value of each user's standby time, it is possible to prompt still more a subject user to input a comment with respect to an evaluation subject.

In addition, in the information-processing device according to the first embodiment of the present invention, the opinion information selection part 2 creates a frequency distribution of each standby time acquired by the input record information acquisition part 4. Then, the opinion information selection part 2 detects a peak in the created frequency distribution, and calculates time shorter than the standby time corresponding to the detected peak as the above-mentioned prescribed time.

In this way, since it is possible to acquire an appropriate presenting timing using a frequency distribution of each user's standby time, it is possible to prompt still more a subject user to input a comment with respect to an evaluation subject.

Besides, in the information-processing device according to the first embodiment of the present invention, based on the textual characteristics-point table shown in FIG. 4 to FIG. 7, and FIG. 9, the evaluation value calculation part 12 is made to be configured to calculate a point of each comment, and to create a comment-point table, and however, it is not limited to this. The evaluation value calculation part 12 may be configured to calculate a point of each comment based on at least one of each table shown in FIG. 4 to FIG. 7, and FIG. 9.

In addition, in the information-processing device according to the first embodiment of the present invention, the evaluation value conversion information storage part 5 is made to be configured to store a table indicating a correspondence relation between the number of emotional expression words or the number of emotional expression symbols in a comment and a point and however, it is not limited to this. The evaluation value conversion information storage part 5 may be configured to store a table indicating a correspondence relation between a point and an academic jargon as well as arithmetic symbol or the like, the number of prescribed terms, the number of prescribed words or the number of prescribed symbols.

That is, the opinion information selection part 2 may be configured to select one or more comments based on at least one of the number of characters, a content percentage of Hiragana, a content percentage of Chinese character, the number of prescribed terms, the number of prescribed words, and the number of prescribed symbols, in a comment.

In addition, in the information-processing device according to the first embodiment of the present invention, the textual characteristics-point table has been configured so that when the number of characters is 11 to 15, the point may become to be the maximum and have a peak, and however, it is not limited to this. It may be such textual characteristics-point table where a plurality of peaks exist in the points.

In addition, in the information-processing device according to the first embodiment of the present invention, the input record information acquisition part 4 may be configured to acquire standby time after each user starts browsing of each evaluation subject until each user inputs a comment, and may be configured to acquire standby time after each user finishes browsing of each evaluation subject until each user inputs a comment. Then, the opinion information selection part 2 calculates a comment presenting timing based on each standby time acquired by the input record information acquisition part 4.

In addition, in the information-processing device according to the first embodiment of the present invention, the opinion information selection part 2, based on the input record information acquired by the input record information acquisition part 4, is made to be configured to determine presenting methods for one or more selected comments and however, it is not limited to this.

In place of the opinion information selection part 2, the opinion information presentation part 3, based on the input record information acquired by the input record information acquisition part 4, may be configured to determine a presenting method of one or more of the comments selected by the opinion information selection part 2, for example, a comment presenting timing to a user.

In addition, in the information-processing device according to the first embodiment of the present invention, the opinion information selection part 2, based on the input record information acquired by the input record information acquisition part 4, is made to be configured to determine a presenting timing of one or more comments selected by the opinion information selection part 2, and however, it is not limited to this.

The opinion information selection part 2 is made to be configured to change not only the presenting timing, but also a color, brightness and font or the like of a comment as a presenting method.

In addition, in the information-processing device according to the first embodiment of the present invention, the input record information acquisition part 4 is made to be configured to acquire standby time of a user until comment input as input record information, and however, it is not limited to this. The input record information acquisition part 4 may be configured to acquire, as input record information, a typing speed by a user, i.e., a character input speed by a user, the number of times in which a backspace key is pressed, and the number of times in which an undoing operation is performed or the like in the case where a user inputs content of opinion.

In addition, the opinion information acquisition part 1 may be configured to acquire primary opinion information indicating each user's content of opinion with respect to an evaluation subject presented to each user, and to acquire primary opinion information indicating each user's content of opinion with respect to an evaluation subject other than the presented evaluation subject.

Specifically, for example, in the case where there exists a community where users make comments to each other with respect to a theme “Let's think about the future”, and there exist a plurality of articles with respect to this theme, the opinion information acquisition part 1 is supposed to acquire a comment on each article from each user participating in this community.

In addition, a comment acquisition and selection by the opinion information acquisition part 1 and opinion information selection part 2 may be performed in advance by batch processing or the like before a user browses an evaluation subject, or may be configured to be performed while a user browses an evaluation subject.

Next, an other embodiment of the present invention will be described using the figures. It is noted that the same reference character will be is given to the same or corresponding part in the figures, and thus the description will not be repeated.

### Second Embodiment

The present embodiment relates to an information-processing device to which input-prompting information other than a past comment is added as compared with the information-processing device according to the first embodiment of the present invention. It is the same as the information-processing device according to the first embodiment except for a content described in the following.

First, a control structure for providing various functions in a information-processing device 202 according to the first embodiment of the present invention will be described.

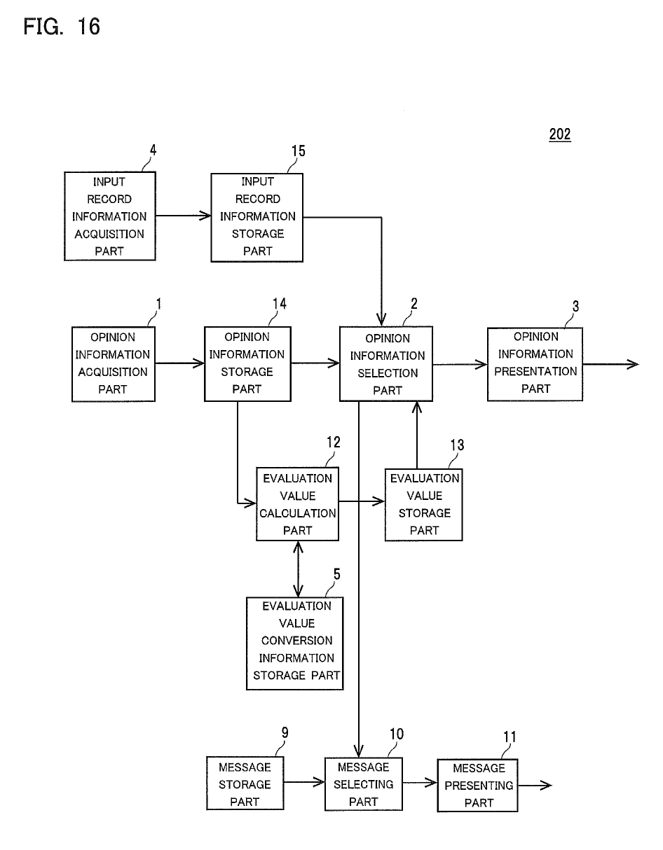

FIG. 16 is a block diagram showing a control structure which a information-processing device according to the first embodiment of the present invention provides.

Each block of the information-processing device 202 shown in FIG. 16 is provided by reading out programs (code) etc. stored in the hard disk 103 and writing to the main memory 102, and making the CPU101 execute them. Besides, a part or all of modules shown in FIG. 16 may be provided by a firmware implemented in hardware. Alternatively, a part or all of control structures shown in FIG. 16 may be realized by dedicated hardware and/or a wiring circuit.

With reference to FIG. 16, an information-processing device 202, as a control structure thereof, as compared with the information-processing device according to the first embodiment of the present invention, further comprises: a message storage part 9; a message selecting part 10; and a message presenting part 11. The message storage part 9 corresponds to the main memory 102 or hard disk 103 shown in FIG. 1, for example. The message presenting part 11 outputs input-prompting information to the hard disk 103 or display 110 shown in FIG. 1, for example.

CPU101 is generally constituted of many units other than each part shown in FIG. 16, and however, other units are not illustrated for simplicity of description.

The message storage part 9 stores a message list which indicates one or more prescribed messages.

The message selecting part 10, as input-prompting information for the purpose of prompting a subject user to input a comment with respect to a presented evaluation subject, selects one or more messages from within the message list stored by the message storage part 9.

The message presenting part 11 presents to a subject user one or more messages selected by the message selecting part 10.

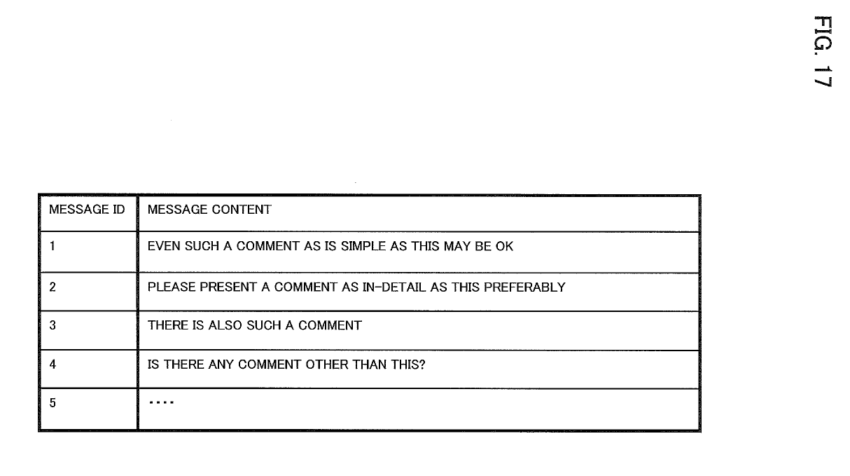

FIG. 17 is a figure showing an example of the message list in the information-processing device according to the second embodiment of the present invention.

With reference to FIG. 17, this message list is a list of a fixed form message which is to be presented to a user as input-prompting information together with a comment, i.e., a facilitation message.

Specifically, this message list includes messages such as: “Even such a comment as is simple as this may be OK”; “Preferably, please present a comment as in-detail as this”; “There is also such a comment”; and “Is there any comment other than this?”.

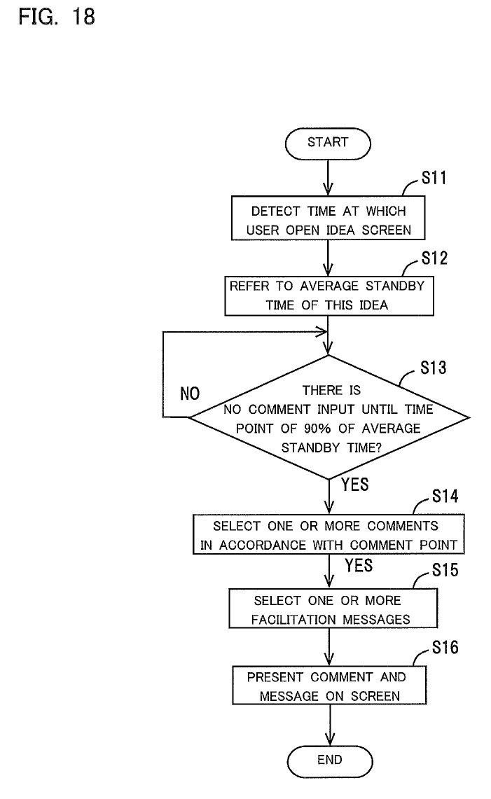

FIG. 18 is a flow chart indicating an operation procedure in the case where the information-processing device according to the second embodiment of the present invention performs comment-prompting processing.

With reference to FIG. 18, since operation of Steps S11 to S14 is the same as operation of Steps S1 to S4 shown in FIG. 12, detailed description is not repeated here.

Next, the message selecting part 10 selects one or more messages from within the message list, and outputs the selected messages to the message presenting part 11. For example, the message selecting part 10 selects one or more messages based on a content of a selected comment, such as messages associated with one or more comments selected by the opinion information selection part 2 (Step S15).

Next, the opinion information presentation part 3 and message presenting part 11 present to a user each a comment received from the opinion information selection part 2 and a message received from the message selecting part 10 (Step S16).

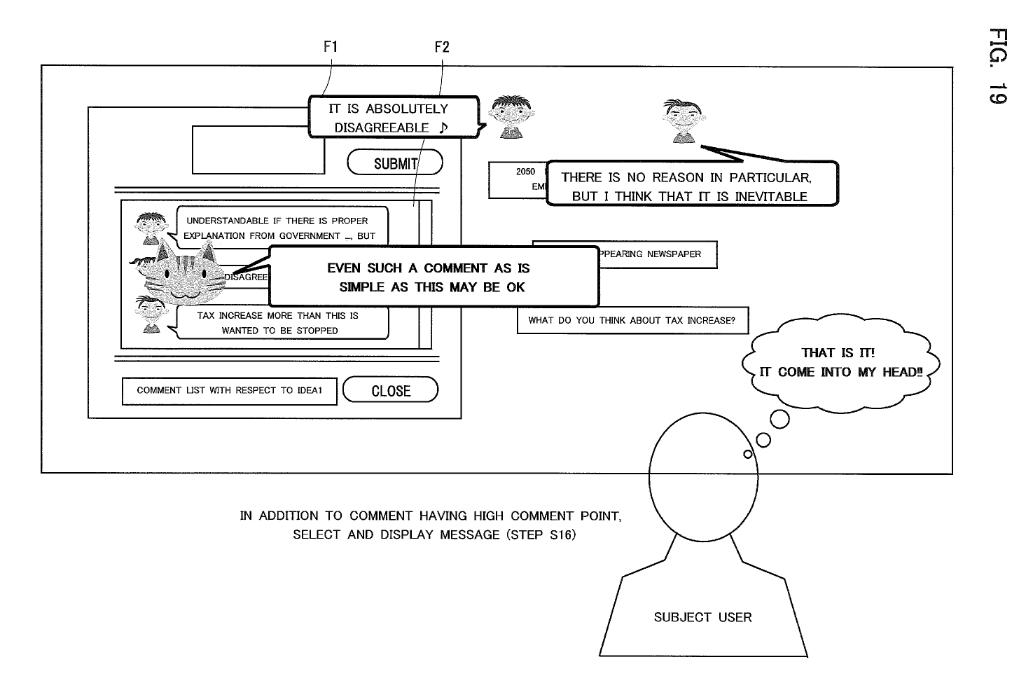

FIG. 19 is a figure showing an example of a display screen for a user in the case where the information-processing device according to the second embodiment of the present invention performs comment-prompting processing.

With reference to FIG. 19, the message selecting part 10, in the case where a user does not think of a comment and a comment with respect to the evaluation subject is not inputted even if 90% for example of the average standby time corresponding to an evaluation subject elapses after a screen as shown in FIG. 18 has been displayed (YES at Step S13), in addition to the comment “It is absolutely disagreeable [symbol] ” and the comment “There is no reason in particular, but I think that it is inevitable” which are comments having a high point for example, outputs the message “Even such a comment as is simple as this may be OK” to the message presenting part 11, and thereby, displays this message on a screen (Step S16).

While looking at a comment and message like this, a user thinks of a comment with respect to the evaluation subject, and inputs this comment.

Besides, in the case where the message selecting part 10 selects one or more messages based on a content of one or more comments selected by the opinion information selection part 2, the opinion information presentation part 3 may be configured not to present a comment.

By such a configuration as this, it becomes possible to deal with flexibly the case where there is a limit to a display space of a screen, or the like.

As mentioned above, in the information-processing device according to the second embodiment of the present invention, the message storage part 9 stores one or more prescribed messages. The message selecting part 10, as input-prompting information for the purpose of prompting a subject user to input content of opinion with respect to a presented evaluation subject, selects one or more messages from among one or more messages stored by the message storage part 9. Then, the message presenting part 11 presents one or more messages selected by the message selecting part 10 to a subject user.

By such a configuration as this, since it is possible to present, to a user, more various pieces of input-prompting information, as compared with the information-processing device according to the first embodiment of the present invention, further, it becomes possible to collect opinions from a large number of users.

In addition, in the information-processing device according to the second embodiment of the present invention, the message selecting part 10, based on content of opinion indicated by one or more pieces of primary opinion information selected by the opinion information selection part 2, selects one or more messages.

By such a configuration as this, it becomes possible to present, to a user, a message in accordance with a content of a selected comment.

Since other configurations and operations are the same as those of the information-processing device according to the first embodiment, detailed descriptions are not repeated here.

Next, an other embodiment of the present invention will be described using the figures. It is noted that the same reference character will be is given to the same or corresponding part in the figures, and thus the description will not be repeated.

### Third Embodiment

The present embodiment relates to an information-processing device which uses a user classification result as compared with the information-processing device according to the first embodiment of the present invention. It is the same as the information-processing device according to the first embodiment except for a content described in the following.

First, a control structure for providing various functions in a information-processing device 203 according to the third embodiment of the present invention will be described.

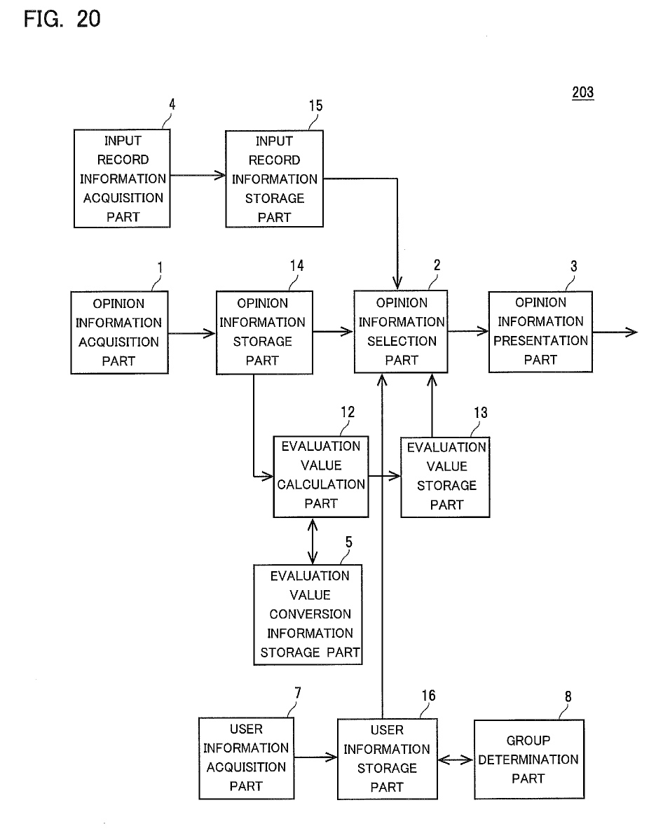

FIG. 20 is a block diagram showing a control structure which a information-processing device according to the third embodiment of the present invention provides.

Each block of the information-processing device 203 shown in FIG. 20 is provided by reading out programs (code) etc. stored in the hard disk 103 and writing to the main memory 102, and making the CPU101 execute them. Besides, a part or all of modules shown in FIG. 20 may be provided by a firmware implemented in hardware. Alternatively, a part or all of control structures shown in FIG. 20 may be realized by dedicated hardware and/or a wiring circuit.

With reference to FIG. 20, an information-processing device 203, as a control structure thereof, as compared with the information-processing device according to the first embodiment of the present invention, further comprises a user information acquisition part 7, a group determination part 8 and a user information storage part 16. The user information storage part 16 corresponds to the main memory 102 or hard disk 103 shown in FIG. 1, for example. CPU101 is generally constituted of many units other than each part shown in FIG. 20, and however, other units are not illustrated for simplicity of description.

The user information acquisition part 7 acquires user information indicating at least any of a subject user's comment with respect to one or more evaluation subjects and a record in which the subject user has inputted a comment, and stores it in the user information storage part 16 as a user table.

The opinion information selection part 2, with reference to the user table stored in the user information storage part 16, selects one or more comments based on the user information acquired by the user information acquisition part 7.

In more details, the group determination part 8, with reference to the user table stored in the user information storage part 16, based on the user information acquired by the user information acquisition part 7, determines from among a plurality of groups a group to which the subject user belongs. For example, the group determination part 8 classifies users into a plurality of groups in accordance with an experience level indicating an experience degree of a comment input, and determines from among a plurality of groups a group to which the subject user belongs based on the user information acquired by the user information acquisition part 7.

The opinion information selection part 2, based on the group to which the subject user belongs determined by the group determination part 8, selects one or more comments.

In addition, the evaluation value conversion information storage part 5 stores a correspondence relation between at least either of a user's comment with respect to one or more evaluation subjects and/or an input record of a comment by a user and an evaluation value.

The evaluation value calculation part 12, based on the correspondence relation stored by the evaluation value conversion information storage part 5, converts a content of the comment acquired by the opinion information acquisition part 1 into an evaluation value.

The opinion information selection part 2, based on a group to which the subject user belongs, selects preferentially a comment of which evaluation value is small or a comment of which evaluation value is large.

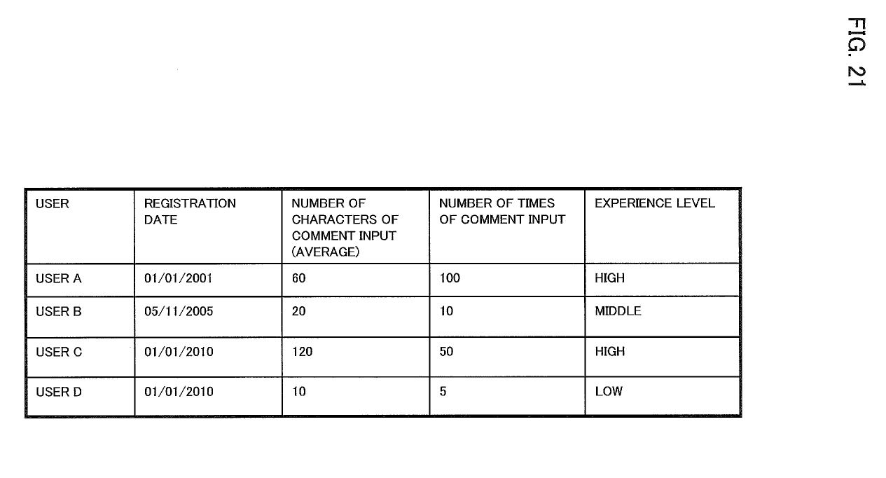

FIG. 21 is a figure showing an example of a user table in an information-processing device according to the third embodiment of the present invention.

With reference to FIG. 21, this user table includes each user's operation log data recorded in the information-processing device 203, for example, a registration date, an average value of the number of input characters in comment and number of times of comment input, and an experience level, with respect to each user.

Besides, a subject of an operation log in this user table may be both an evaluation subject which a subject user is browsing and the other evaluation subject, or may be either of a presented evaluation subject which a subject user is browsing and/or the other evaluation subject. In addition, the user table may be configured to include standby time until a comment input described in the first embodiment of the present invention as an input record of a comment by each user.

The group determination part 8 makes at least one of that a registration date is old, and that the number of input characters is large, and that the number of times of input is large as a condition for a user to have a high experience level.

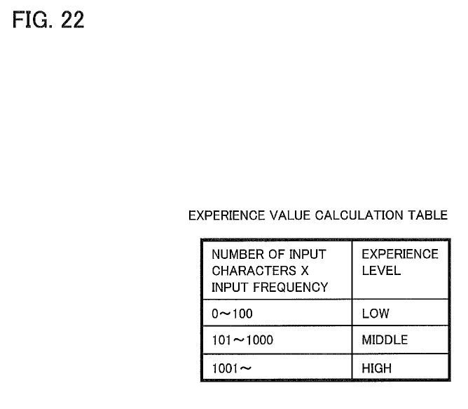

FIG. 22 is a figure showing an example of an experience value calculation table in the information-processing device according to the third embodiment of the present invention.

With reference to FIG. 22, this experience value calculation table is the table indicating a correspondence relation between the hitherto total number of input characters of each user and an experience level. Here, the total number of input characters is calculated by the number of comment input characters×the number of times of comment input.

Specifically, in this experience value calculation table, the experience level of a user where the total number of input characters is 0 to 100 is “low”, and the experience level of a user where the total number of input characters is 101 to 1000 is “middle”, and the experience level of a user where the total number of input characters is no more than 1001 is “high”.

The user information storage part 16 stores this experience value calculation table. The group determination part 8, for example, calculates the total number of input characters from an average value of each user's number of input characters in comment and the number of times of comment input, and calculates each user's experience level with reference to this experience value calculation table, and registers it in the user table stored in the user information storage part 16.

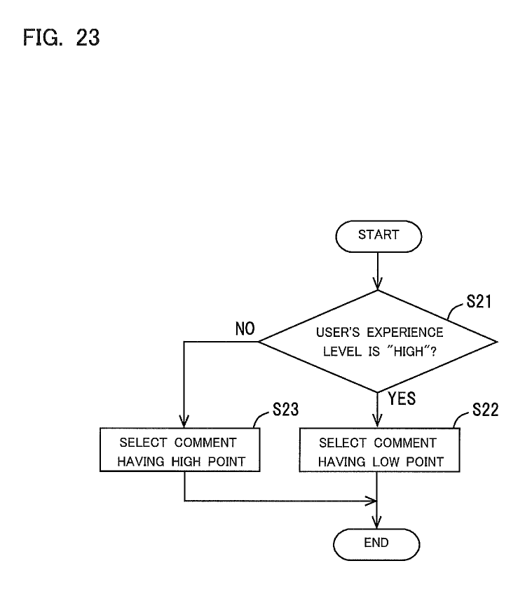

FIG. 23 is a flow chart indicating an operation procedure in the case where the information-processing device according to the third embodiment of the present invention performs comment selection. FIG. 23 indicates in detail the operation of Step S4 in FIG. 12, and Step S14 in FIG. 18.

With reference to FIG. 23, first, the opinion information selection part 2, with reference to the user table stored in the user information storage part 16, acquires an experience level of a subject user to which input-prompting information is to be presented, for example, a user who is browsing a screen which the information-processing device 203 displays, and who has not inputted a comment yet. Then, the opinion information selection part 2, in the case where a subject user's experience level is “high” (YES at Step S21), with reference to the comment-point table stored in the evaluation value storage part 13, selects a comment of which point is low (Step S22). This comment-point table is the comment-point table shown in FIG. 3, for example.

On the other hand, the opinion information selection part 2, in the case where a subject user's experience level is “low” or “middle” (NO at Step S21), with reference to the comment-point table stored in the evaluation value storage part 13, selects comment of which point is high (Step S23).

Besides, the opinion information selection part 2 may select a comment of which point is low in the case where a subject user's experience level is “high” or “middle”, and may select a comment of which point is high in the case where a subject user's experience level is “low”.

In this way, the information-processing device 203, to a user where an experience level is high and an advanced comment can be expected to be inputted, presents an advanced comment of which point is low. That is, by showing a detailed comment, it is possible to induce more comments.

In addition, the information-processing device 203, to a user where an experience level is low and a mental threshold with respect to a comment input is needed to be reduced, presents a comment of which point is high, i.e., a comment which seems to be easy to be inputted.

[Comment Presenting Method (Part 3)]

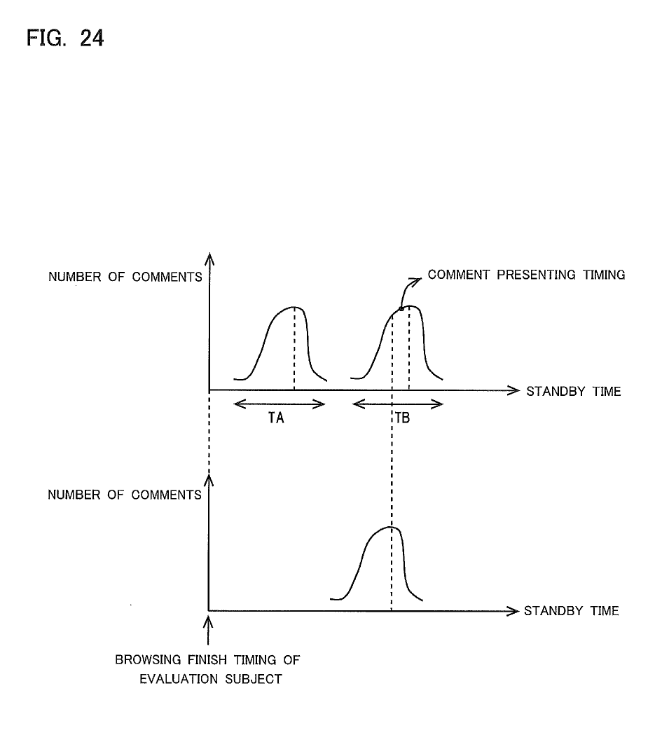

FIG. 24 is a figure showing other example of a frequency distribution of standby time until comment input with respect to a certain evaluation subject.

The opinion information selection part 2, for every evaluation subject, creates a frequency distribution of each standby time stored in the input record information storage part 2.

In addition, the user information acquisition part 7 acquires user information indicating standby time after a prescribed timing until a subject user starts inputting of a comment with respect to one or more evaluation subjects.

The opinion information selection part 2, in the case of detecting a plurality of peaks in the created frequency distribution shown in FIG. 24, based on the user information acquired by the user information acquisition part 7, creates a frequency distribution of subject user's each standby time. Then, the opinion information selection part 2 selects any of a plurality of peaks based on the created subject user's frequency distribution and calculates, as a comment presenting timing, time shorter than the standby time corresponding to the selected peak.

Specifically, a frequency distribution of standby time until each user's comment input with respect to a certain evaluation subject has two peaks in the period TA and period TB. In this case, the opinion information selection part 2, comparing the frequency distribution indicated in the upper part of FIG. 24 with the subject user's frequency distribution indicated in the lower part of FIG. 24, selects the peak of the side which is included in the subject user's frequency distribution among two peaks indicated in the upper part of FIG. 24, for example. Here, since a subject user has a tendency to input a comment in the side of the period TB, the opinion information selection part 2 presents a comment at a timing little before the peaking time in the period TB.

As mentioned above, in the information-processing device according to the third embodiment of the present invention, the user information acquisition part 7 acquires user information indicating at least either of subject user's content of opinion with respect to one or more evaluation subjects and/or a record in which a subject user has inputted content of opinion. Then, the opinion information selection part 2 selects one or more peaces of primary opinion information based on user information acquired by the user information acquisition part 7.

By such a configuration as this, since it is possible to select and present an optimal comment for every user, it becomes possible to provide a more advanced comment-prompting system.

In addition, in the information-processing device according to the third embodiment of the present invention, the group determination part 8, based on the user information acquired by the user information acquisition part 7, determines from among a plurality of groups a group to which a subject user belongs. Then, the opinion information selection part 2 selects one or more pieces of primary opinion information based on a group to which a subject user belongs.

By such a configuration as this, by carrying out grouping a large number of users based on a certain criterion, it is possible to select and present an optimal comment efficiently.

In addition, in the information-processing device according to the third embodiment of the present invention, the evaluation value conversion information storage part 5 stores a correspondence relation between at least either of user's content of opinion with respect to one or more evaluation subjects and/or an input record of the content of opinion by a user and the evaluation value. The evaluation value calculation part 12 converts the content of opinion indicated by the primary opinion information acquired by the opinion information acquisition part 1 into an evaluation value based on the correspondence relation stored by the evaluation value conversion information storage part 5. Then, the opinion information selection part 2 acquires an experience level of content of opinion input of a subject user based on the user information acquired by the user information acquisition part 7, and in accordance with highness and lowness of the subject user's experience level, selects preferentially primary opinion information of which evaluation value is small or primary opinion information of which evaluation value is large.

In this way, by changing a comment selection criterion based on an evaluation value in accordance with a user's experience degree, it is possible to select and present a further optimal comment for every user.

In addition, in the information-processing device according to the third embodiment of the present invention, the user information acquisition part 7 acquires user information indicating standby time after a prescribed timing until a subject user starts inputting of content of opinion with respect to one or more evaluation subjects. The opinion information selection part 2, in the case of detecting a plurality of peaks in the created frequency distribution, based on the user information acquired by the user information acquisition part 7, creates a frequency distribution of subject user's each standby time. Then, the opinion information selection part 2 selects any of a plurality of peaks based on the created subject user's frequency distribution, and calculates, as a prescribed time, time shorter than the standby time corresponding to the selected peak.

By such a configuration as this, even in the case where a plurality of peaks exist in a frequency distribution of each user's standby time, an appropriate presenting timing can be acquired for every user.

Since other configurations and operations are the same as those of the information-processing device according to the first embodiment, detailed descriptions are not repeated here.

Next, an other embodiment of the present invention will be described using the figures. It is noted that the same reference character will be is given to the same or corresponding part in the figures, and thus the description will not be repeated.

### Fourth Embodiment

The present embodiment relates to an information-processing device which changes a point calculation method in accordance with a user classification result, as compared with the information-processing device according to the third embodiment. It is the same as the information-processing device according to the third embodiment except for a content described in the following.

The evaluation value conversion information storage part 5 has stored a comment point calculation table shown in FIG. 1, for example.

The evaluation value calculation part 12, based on the correspondence relation stored by the evaluation value conversion information storage part 5, i.e., the comment point calculation table and the group to which the subject user belongs, converts a content of the comment acquired by the opinion information acquisition part 1 into an evaluation value, and creates a comment-point table and stores it in the evaluation value storage part 13.

Specifically, the evaluation value calculation part 12, by adding together a point of the text length and a point of the percentage of Hiragana in the comment point calculation table shown in FIG. 10, calculates a point for a user whose experience level is “low” or “middle”. In addition, the evaluation value calculation part 12, by adding together a point of the text length and point of the percentage of Chinese character in the comment point calculation table shown in FIG. 10, calculates a point for a user whose experience level is “high”.

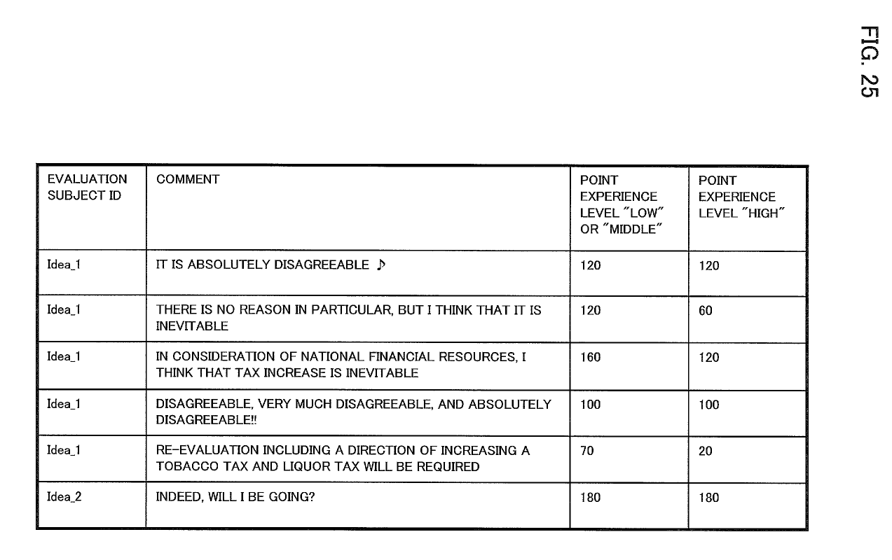

FIG. 25 is a figure showing an example of a comment-point table in the information-processing device according to the fourth embodiment of the present invention.

With reference to FIG. 25, in this comment-point table, indicated are comments with respect to an evaluation subject of which an evaluation subject ID is Idea-1 and an evaluation subject of which an evaluation subject ID is Idea-2, as well as a point for each comment.

For example, an evaluation subject of which evaluation subject ID is Idea-1 is the question “what do you think about tax increase?”, and with respect to this question, this comment-point table shows that: with respect to the comment “It is absolutely disagreeable [symbol] ”, the point for a user whose experience level is “low” or “middle” is 120 and the point for a user whose experience level is “high” is 120; with respect to the comment “There is no reason in particular, but I think that it is inevitable”, the point for a user whose experience level is “low” or “middle” is 120 and the point for a user whose experience level is “high” is 60; with respect to the comment “In consideration of national financial resources, I think that tax increase is inevitable”, the point for a user whose experience level is “low” or “middle” is 160 and the point for a user whose experience level is “high” is 120; with respect to the comment “Disagreeable, very much disagreeable!!, and absolutely disagreeable”, the point for a user whose experience level is “low” or “middle” is 100 and the point for a user whose experience level is “high” is 100; and with respect to the comment “Re-evaluation including a direction of increasing a tobacco tax and liquor tax will be required”, the point for a user whose experience level is “low” or “middle” is 70 and the point for a user whose experience level is “high” is 20.

In addition, an evaluation subject of which evaluation subject ID is Idea-2 is information with respect to a certain event, and with respect to the information, this comment-point table shows that with respect to the comment “Indeed, will I be going?”, the point for a user whose experience level is “low” or “middle” is 180 and the point for a user whose experience level is “high” is 180.

The opinion information selection part 2, with reference to such comment-point table as this, selects a comment based on a point of each comment.

Here, the opinion information selection part 2 selects one or more comments based on the evaluation value converted by the evaluation value calculation part 12 and the group to which the subject user belongs.

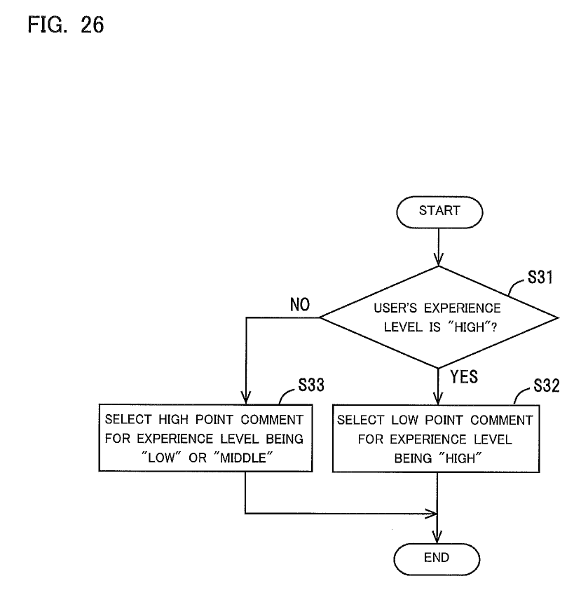

FIG. 26 is a flow chart indicating an operation procedure in the case where the information-processing device according to the fourth embodiment of the present invention performs comment selection. FIG. 26 indicates in detail operation of Step S4 in FIG. 12, and Step S14 in FIG. 18.

With reference to FIG. 26, first, the opinion information selection part 2, with reference to the user table stored in the user information storage part 16, acquires an experience level of a subject user to which input-prompting information is to be presented, for example, a user who is browsing a screen which the information-processing device according to the fourth embodiment of the present invention displays, and who has not inputted a comment yet. Then, the opinion information selection part 2, in the case where a subject user's experience level is “high” (YES at Step S31), with reference to the comment-point table stored in the evaluation value storage part 13, selects a comment having a low point for an experience level “high” (Step S32).

On the other hand, the opinion information selection part 2, in the case where a subject user's experience level is “low” or “middle” (NO at Step S31), with reference to the comment-point table stored in the evaluation value storage part 13, selects a comment having a high point for an experience level “low” or “middle” (Step S33).

In this way, the information-processing device 204 changes a point calculation method of a comment in the case where a subject user's experience level is “high” and in the case where a subject user's experience level is “low” or “middle”.

Then, the information-processing device 204, to a user where an experience level is high and an advanced comment can be expected to be inputted, presents an advanced comment having a low point for an experience level “high”. That is, by showing a detailed comment, it is possible to induce more comments.

In addition, the information-processing device 204, to a user where an experience level low, and a mental threshold with respect to a comment input is needed to be reduced, presents a comment having a high point for an experience level “low” or “middle”, i.e., a comment which seems to be easy to be inputted.

As mentioned above, in the information-processing device according to the fourth embodiment of the present invention, the evaluation value conversion information storage part 5 stores a correspondence relation between at least either of user's content of opinion with respect to an evaluation subject and/or an input record of content of opinion by a user and the evaluation value. The evaluation value calculation part 12, based on the correspondence relation stored by the evaluation value conversion information storage part 5 and the group to which the subject user belongs, converts the content of opinion indicated by the primary opinion information acquired by the opinion information acquisition part 1 into an evaluation value. Then, the opinion information selection part 2 selects one or more pieces of primary opinion information based on the evaluation value converted by the evaluation value calculation part 12 and the group to which the subject user belongs.

By such a configuration as this, since a calculation method of an evaluation value and a selection method of a comment can be switched for every group to which a user belongs, it is possible to select a further optimal comment for every user.

Therefore, in the information-processing device according to the fourth embodiment of the present invention, as compared with the information-processing device according to the third embodiment of the present invention, further, it becomes possible to select and present an optimal comment for every user, and therefore, it is possible further to provide a more advanced comment-prompting system.

Besides, in the information-processing device according to the fourth embodiment of the present invention, assumed has been the configuration in which an evaluation value calculation method and a comment selection method are switched between a case where an experience level is “low” or “middle” and a case where an experience level is “high”, and however, it is not limited to this. It may be a configuration in which an evaluation value calculation method and a comment selection method are switched between a case where an experience level is “low” and a case where an experience level is “high” or “middle”, and may be a configuration in which an evaluation value calculation method and a comment selection method are switched for every case where an experience level is “low”, “middle”, or “high”.

Since other configurations and operations are the same as those of the information-processing device according to the third embodiment, detailed descriptions are not repeated here.

Next, an other embodiment of the present invention will be described using the figures. It is noted that the same reference character will be is given to the same or corresponding part in the figures, and thus the description will not be repeated.

### Fifth Embodiment

The present embodiment relates to an information-processing device which converts other characteristics of a comment into an evaluation value as compared with the information-processing device according to the first embodiment of the present invention. It is the same as the information-processing device according to the first embodiment except for a content described in the following.

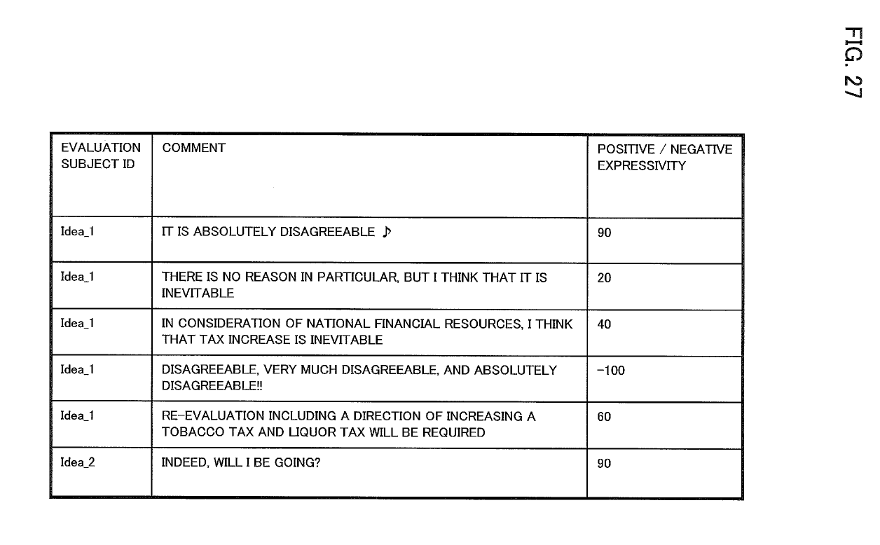

FIG. 27 is a figure showing an example of a comment-expressivity table in the information-processing device according to the fifth embodiment of the present invention.

With reference to FIG. 27, this comment-expressivity table is the table indicating a correspondence relation between a comment which is primary opinion information indicating user's content of opinion with respect to an evaluation subject and an expressivity indicating a degree whether this comment is positive expression or negative expression

In this comment-expressivity table, indicated are a comment with respect to an evaluation subject of which evaluation subject ID is Idea_{—}1 and an evaluation subject of which evaluation subject ID is Idea_{—}2, as well as an expressivity of each comment.

For example, an evaluation subject of which evaluation subject ID is Idea-1 is the question “what do you think about tax increase?”, and with respect to this question, this comment-expressivity table shows that: the expressivity of the comment “It is absolutely disagreeable [symbol] ” is 90; the expressivity of the comment “There is no reason in particular, but I think that it is inevitable” is 20; the expressivity of the comment “In consideration of national financial resources, I think that tax increase is inevitable” is 40; the expressivity of the comment “Disagreeable, very much disagreeable!!, and absolutely disagreeable” is −100; and the expressivity of the comment “Re-evaluation including a direction of increasing a tobacco tax and liquor tax will be required” is 60.

In addition, an evaluation subject of which evaluation subject ID is Idea-2 is information with respect to a certain event, and with respect to the information, this comment-point table shows that the expressivity of the comment “Indeed, will I be going?” is 90.

The evaluation value storage part 13 stores this comment-expressivity table. The opinion information selection part 2, with reference to the comment-expressivity table stored in the evaluation value storage part 13, selects a comment based on the expressivity of each comment.

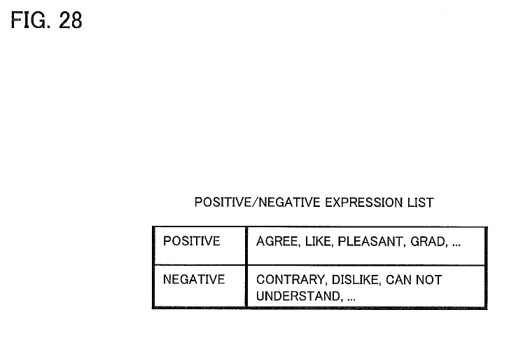

FIG. 28 is a figure showing an example of a positive/negative expression list in the information-processing device according to the fifth embodiment of the present invention.

With reference to FIG. 28, this positive/negative expression list, as a positive expression word, includes “agree”, “like”, “pleasant”, and “glad” for example, and as a negative expression word, includes “contrary”, “dislike”, and “can not understand”, for example.

The evaluation value conversion information storage part 5 stores this positive/negative expression list. The evaluation value calculation part 12, with reference to the positive/negative expression list stored in the evaluation value conversion information storage part 5, detects the positive expression word and negative expression word in a comment acquired by the opinion information acquisition part 1, and calculates an expressivity of this comment based on the detection result.

For example, the evaluation value calculation part 12, calculates an expressivity of each comment in a range of −100 to 100 based on the number of positive expression words and number of negative expression words in each comment, and registers it in the comment-expressivity table.

Alternatively, the evaluation value calculation part 12 assumes an expressivity of a positive expression word as a positive value and an expressivity of a negative expression word as a negative value, and gives a weighting to each expression word based on whether an emphasis expression such as “very much” has been added, and thereby, an expressivity of each comment may be calculated.

In addition, the user information acquisition part 7 calculates an average value with respect to an expressivity of a subject user's comment with respect to one or more evaluation subjects, and registers it in a user table in the user information storage part 16.

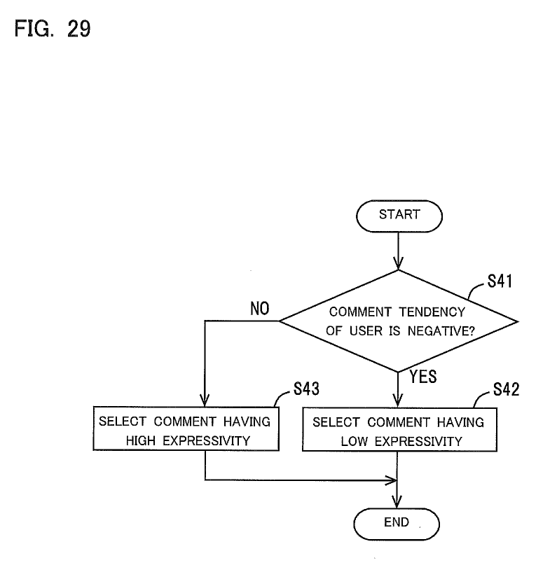

FIG. 29 is a flow chart indicating an operation procedure in the case where the information-processing device according to the fifth embodiment of the present invention performs comment selection. FIG. 29 indicates in detail operation of Step S4 in FIG. 12, and Step S14 in FIG. 18.

With reference to FIG. 29, first, the opinion information selection part 2, with reference to the user table stored in the user information storage part 16, selects a comment near to a tendency of the comment inputted in the past by a subject user to which input-prompting information is to be presented, for example, the user who is browsing a screen which the information-processing device according to the fifth embodiment of the present invention displays and who has not inputted a comment yet.

That is, the opinion information selection part 2, in the case where comment tendency of a subject user is negative, for example, an average expressivity of the subject user's comment is less than a prescribed value (YES at Step S41), with reference to the comment-expressivity table stored in the evaluation value storage part 13, selects a comment of which expressivity is low (Step S42).

On the other hand, the opinion information selection part 2, in the case where comment tendency of a subject user is affirmative, for example, an average expressivity of the subject user's comment is no less than a above-mentioned prescribed value (NO at Step S41), with reference to the comment-expressivity table stored in the evaluation value storage part 13, selects a comment of which expressivity is high (Step S43).

In this way, in the information-processing device according to the fifth embodiment of the present invention, the evaluation value calculation part 12 calculates an expressivity indicating an affirmation expression degree and negative expression degree of a comment acquired by the opinion information acquisition part 1. Then, the opinion information selection part 2, based on whether a group to which a subject user belongs, i.e., a comment tendency is affirmative or negative, selects preferentially a comment of which expressivity is small or a comment of which expressivity is large.

For example, the opinion information selection part 2, with respect to a user where an average value of an expressivity of a comment is low and there is a tendency to input a negative comment, presents a comment of which expressivity is low. That is, by showing an aggressive or negative comment, it is possible to induce more comments.

In addition, the opinion information selection part 2, with respect to a user where an average value of an expressivity of a comment is high and there is a tendency to input a affirmative comment, presents a comment of which expressivity is high, i.e., an affirmative comment.

Therefore, in the information-processing device according to the fifth embodiment of the present invention, since it is possible to select and present an optimal comment for every user, it becomes possible to provide a more advanced comment-prompting system.

Since other configurations and operations are the same as those of the information-processing device according to the first embodiment, detailed descriptions are not repeated here.

Next, an other embodiment of the present invention will be described using the figures. It is noted that the same reference character will be is given to the same or corresponding part in the figures, and thus the description will not be repeated.

### Sixth Embodiment

The present embodiment relates to an information-processing device which uses content of opinion with respect to primary opinion information, and an input record of this content of opinion as compared with the information-processing device according to the first embodiment of the present invention. It is the same as the information-processing device according to the first embodiment except for a content described in the following.

The input record information acquisition part 4, with respect to each user's primary comment (primary opinion information) with respect to one or more evaluation subjects, acquires input record information indicating a record in which each user has inputted content of opinion.

The opinion information selection part 2, based on the input record information acquired by the input record information acquisition part 4, selects one or more primary comments. For example, the opinion information selection part 2, from among a plurality of primary comments acquired by the opinion information acquisition part 1, selects one or more primary comments based on a content of the primary comments such as textual characteristics, and from among the selected primary comments, selects one or more primary comments as input-prompting information based on the above-mentioned input record information.

In addition, the opinion information acquisition part 1 acquires a secondary comment (secondary opinion information) indicating each user's content of opinion with respect to a primary comment.

The pinion information selection part 2 selects one or more primary comments based on the secondary comment. In more details, the opinion information selection part 2, from among a plurality of primary comments acquired by the opinion information acquisition part 1, selects one or more primary comments based on a content of the primary comment such as textual characteristics, and from among selected primary comments, selects one or more primary comments as input-prompting information based on a content of the secondary comment.

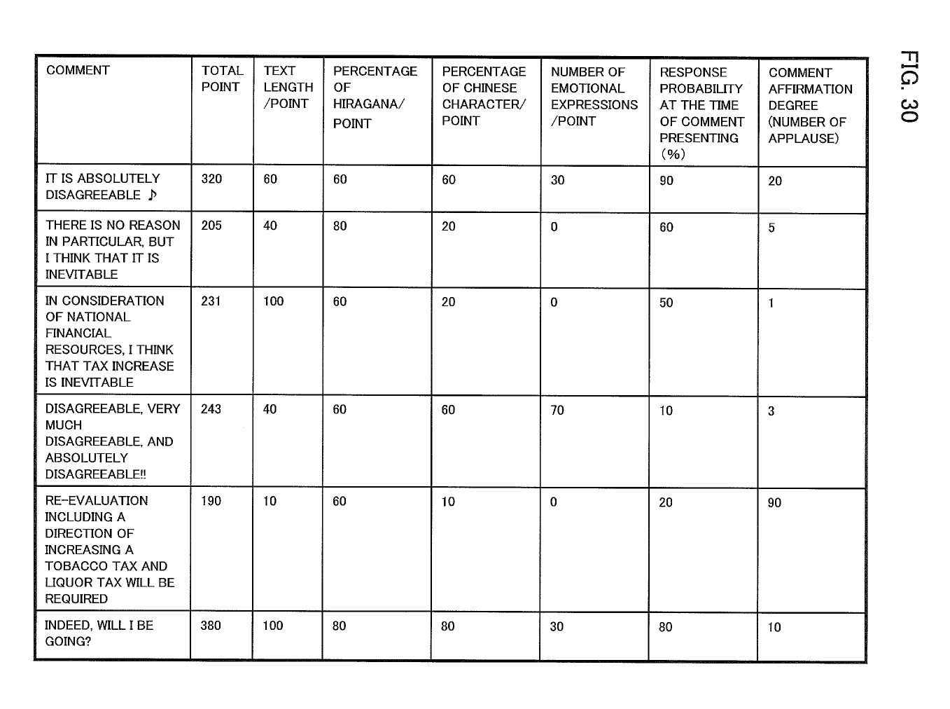

FIG. 30 is a figure showing an example of a comment point calculation table in the information-processing device according to the sixth embodiment of the present invention.

With reference to FIG. 30, this comment point calculation table, as compared with the comment point calculation table shown in FIG. 10, a response probability at the time of comment presenting and comment affirmation degree are added.

Here, the response probability at the time of comment presenting means a probability that a new comment is inputted when this comment is presented, and it can be said that the higher this response probability is, the comment is the higher in the comment input prompting effect.

In addition, the comment affirmation degree is the number of times in which other users look at this comment and click an applause button, for example, and it can be said that the higher this affirmation degree is, the comment is the higher in the comment input prompting effect.

Specifically, this comment point calculation table shows that: with respect to the comment “It is absolutely disagreeable [symbol] ”, the response probability at the time of comment presenting is 90%, and the comment affirmation degree is 20; with respect to the comment “There is no reason in particular, but I think that it is inevitable”, the response probability at the time of comment presenting is 60%, and the comment affirmation degree is 5; with respect to the comment “In consideration of national financial resources, I think that tax increase is inevitable”, the response probability at the time of comment presenting is 50%, and the comment affirmation degree is 1; with respect to the comment “Disagreeable, very much disagreeable!!, and absolutely disagreeable”, the response probability at the time of comment presenting is 10%, and the comment affirmation degree is 3; with respect to the comment “Re-evaluation including a direction of increasing a tobacco tax and liquor tax will be required”, the response probability at the time of comment presenting is 20%, and the comment affirmation degree is 90; and with respect to the comment “Indeed, will I be going?”, the response probability at the time of comment presenting is 80%, and the comment affirmation degree is 10.

The input record information acquisition part 4 calculates the above-mentioned response probability, and stores it in the input record information storage part 15. The evaluation value calculation part 12 acquires the response probability from the input record information storage part 15, and registers it into the comment point calculation table.

The opinion information selection part 2, in the case of presenting one comment for example, when a plurality of comments of which point are highest and which have the same value exist, with reference to this comment point calculation table, selects preferentially a comment where a response probability at the time of comment presenting and comment affirmation degree are high.

As mentioned above, in the information-processing device according to the sixth embodiment of the present invention, the input record information acquisition part 4 acquires a record in which each user inputs content of opinion with respect to primary opinion information, for example, input record information indicating a response probability. Then, the opinion information selection part 2, based on the input record information acquired by the input record information acquisition part 4, selects one or more pieces of primary opinion information.

In this way, since by using a record in which each user inputs a secondary comment with respect to a primary comment, it is possible to select and present further a primary comment which is high in a comment input prompting effect, it becomes possible to provide a more advanced comment-prompting system.

In addition, in the information-processing device according to the sixth embodiment of the present invention, the opinion information selection part 2, from among a plurality of pieces of primary opinion information acquired by the opinion information acquisition part 1, selects one or more pieces of primary opinion information based on content of opinion indicated by primary opinion information. Then, the opinion information selection part 2, from among selected primary opinion information, selects one or more pieces of primary opinion information as input-prompting information based on input record information.

By such a configuration as this, from among a plurality of primary comments which are equivalent in a content, it becomes possible to select appropriately a primary comment to be presented to a user.

In addition, in the information-processing device according to the sixth embodiment of the present invention, the opinion information acquisition part 1, further, acquires secondary opinion information indicating each user' content of opinion with respect to primary opinion information. Then, the opinion information selection part 2 selects one or more pieces of primary opinion information based on content of opinion indicated by secondary opinion information.

In this way, since by using a secondary comment indicating content of opinion with respect to a primary comment, it is possible to select and present further a primary comment which is high in a comment input prompting effect, it becomes possible to provide a more advanced comment-prompting system.

In addition, in the information-processing device according to the sixth embodiment of the present invention, the opinion information selection part 2, from among a plurality of pieces of primary opinion information acquired by the opinion information acquisition part 1, selects one or more pieces of primary opinion information based on content of opinion indicated by primary opinion information. Then, the opinion information selection part 2, from among selected primary opinion information, selects one or more pieces of primary opinion information as input-prompting information based on content of opinion indicated by secondary opinion information.

By such a configuration as this, from among a plurality of primary comments which are equivalent in a content, it becomes possible to select appropriately a primary comment to be presented to a user.

Besides, the opinion information selection part 2, in the case where a plurality of comments of which point are highest and which have the same value exist, may be configured to select a comment based on either of a response probability at the time of comment presenting and/or comment affirmation degree.

In addition, the opinion information selection part 2, among pieces of information in the comment point calculation table shown in FIG. 30, may be configured not to use a point with respect to textual characteristics. That is, the opinion information selection part 2, among pieces of information in the comment point calculation table shown in FIG. 30, based on at least either of a response probability at the time of comment presenting and/or comment affirmation degree, may be configured to select one or more comments from among each comments stored in the evaluation value storage part 13.

Since other configurations and operations are the same as those of the information-processing device according to the first embodiment, detailed descriptions are not repeated here.

Next, an other embodiment of the present invention will be described using the figures. It is noted that the same reference character will be is given to the same or corresponding part in the figures, and thus the description will not be repeated.

### Seventh Embodiment

The present embodiment relates to an information-processing device which uses characteristics of a subject user's comment as compared with the information-processing device according to the third embodiment. It is the same as the information-processing device according to the third embodiment except for a content described in the following.

The opinion information selection part 2, based on subject user's content of opinion with respect to one or more evaluation subjects, selects one or more comments from among a plurality of comments acquired by the opinion information acquisition part 1.

In more details, the user information acquisition part 7 acquires user information indicating a subject user's comment with respect to one or more evaluation subjects.

The opinion information selection part 2 selects one or more primary comments based on user information acquired by the user information acquisition part 7.

Specifically, the opinion information selection part 2, with reference to a user table shown in FIG. 21 stored in the user information storage part 16, selects a comment near to characteristics of the comment inputted by a subject user in the past. For example, the opinion information selection part 2, since an average value of the number of comment input characters of user A who is a subject user is 60, in the comment point calculation table shown in FIG. 10, selects a comment where an average value of the number of input characters is the nearest, i.e., the comment “It is absolutely disagreeable [symbol] ” where a point of the text length is 60, and presents it to the user A.

Besides, the opinion information selection part 2, for example, in the comment point calculation table shown in FIG. 10, may be configured to select a comment near to characteristics of the comment inputted by the subject user in the past with respect to other textual characteristics other than the number of input characters.

In addition, the opinion information selection part 2, for example, in the comment point calculation table shown in FIG. 10, may be configured to select a comment having a point nearest to an average value of points of the comment inputted by a subject user in the past.

By such a configuration as this, since it is possible to select and present an optimal comment for every user, it becomes possible to provide a more advanced comment-prompting system.

Since other configurations and operations are the same as those of the information-processing device according to the third embodiment, detailed descriptions are not repeated here.

A part or all of the above-mentioned embodiments are described also as the following additional statements, and however, the scope of the present invention is not limited to the following additional statements.

[Additional Statement 1]

An information-processing device, comprising:

an opinion information acquisition part configured to acquire primary opinion information indicating each user's content of opinion with respect to one or more evaluation subjects;

an opinion information selection part configured to select one or more pieces of said primary opinion information, as input-prompting information for the purpose of prompting a subject user to input content of opinion with respect to a presented evaluation subject which is a evaluation subject presented to said subject user from among a plurality of pieces of said primary opinion information acquired by said opinion information acquisition part; and

an opinion information presentation part configured to present, to said subject user, one or more pieces of said primary opinion information selected by said opinion information selection part.

[Additional Statement 2]

The information-processing device according to Additional statement 1, wherein

said primary opinion information is textual information, and

said information-processing device further comprises:

an evaluation value conversion information storage part configured to store a correspondence relation between textual information characteristics and a evaluation value; and

an evaluation value calculation part configured to convert, based on said correspondence relation stored by said evaluation value conversion information storage part, content of opinion indicated by said primary opinion information acquired by said opinion information acquisition part into an evaluation value, wherein

said opinion information selection part selects one or more pieces of said primary opinion information based on an evaluation value converted by said evaluation value calculation part.

[Additional Statement 3]

The information-processing device according to Additional statement 2, wherein

said evaluation value conversion information storage part is provided with a plurality of ranges with respect to a degree of said textual information characteristics, and stores said correspondence relation indicating an evaluation value for every said range.

[Additional Statement 4]

The information-processing device according to Additional statement 2 or Additional statement 3, wherein

said evaluation value conversion information storage part stores said correspondence relation in which the nearer the number of characters of said primary opinion information approaches to a prescribed value, the larger an evaluation value is.

[Additional Statement 5]

The information-processing device according to any of Additional statements 2 to 4, wherein

said evaluation value conversion information storage part stores said correspondence relation in which the nearer a content percentage of Hiragana in said primary opinion information approaches to a prescribed value, the larger an evaluation value is.

[Additional Statement 6]

The information-processing device according to any of Additional statements 2 to 5, wherein

said evaluation value conversion information storage part stores said correspondence relation in which the nearer a content percentage of Chinese character in said primary opinion information approaches to a prescribed value, the larger an evaluation value is.

[Additional Statement 7]

The information-processing device according to any of Additional statements 2 to 6, wherein

said evaluation value conversion information storage part stores said correspondence relation in which the nearer the number of emotional expression words or emotional expression symbols in said primary opinion information approaches to a prescribed value, the larger an evaluation value is.

[Additional Statement 8]

The information-processing device according to any of Additional statements 1 to 7, wherein

said primary opinion information is textual information, and

said opinion information selection part selects one or more pieces of said primary opinion information based on at least one of the number of characters, a content percentage of Hiragana, a content percentage of Chinese character, the number of prescribed terms, the number of prescribed words, and the number of prescribed symbols, in said primary opinion information.

[Additional Statement 9]

The information-processing device according to any of Additional statements 1 to 8, further comprising

an input record information acquisition part configured to acquire input record information indicating a record where each user has inputted content of opinion with respect to one or more evaluation subjects,

wherein

said opinion information selection part selects one or more pieces of said primary opinion information based on said input record information acquired by said input record information acquisition part.

[Additional Statement 10]

The information-processing device according to Additional statement 9, further comprising:

an evaluation value conversion information storage part configured to store a correspondence relation between an input record of said content of opinion by a user and an evaluation value; and

an evaluation value calculation part configured to convert, based on said correspondence relation stored by said evaluation value conversion information storage part, said input record information corresponding to said primary opinion information acquired by said opinion information acquisition part into an evaluation value,

wherein

said opinion information selection part selects one or more pieces of said primary opinion information based on an evaluation value converted by said evaluation value calculation part.

[Additional Statement 11]

The information-processing device according to Additional statement 10, wherein

said evaluation value conversion information storage part stores said correspondence relation in which the shorter an input time of said content of opinion by a user is, the larger an evaluation value is.

[Additional Statement 12]

The information-processing device according to any of Additional statements 1 to 11, further comprising:

a message storage part configured to store one or more prescribed messages;

a message selecting part configured to select one or more said messages, as input-prompting information for the purpose of prompting said subject user to input content of opinion with respect to said presented evaluation subject, from among one or more said messages stored by said message storage part; and

a message presenting part configured to present one or more said messages selected by said message selecting part to said subject user.

[Additional Statement 13]

The information-processing device according to Additional statement 12, wherein

said message selecting part, based on content of opinion indicated by one or more pieces of said primary opinion information selected by said opinion information selection part, selects one or more said messages.

[Additional Statement 14]

The information-processing device according to Additional statement 13, wherein

said message presenting part, in place of said opinion information presentation part presenting said primary opinion information, presents one or more said messages to said subject user.

[Additional Statement 15]

The information-processing device according to any of Additional statements 1 to 14, further comprising

a user information acquisition part configured to acquire user information indicating at least any of said subject user's content of opinion with respect to one or more evaluation subjects and a record in which said subject user has inputted said content of opinion,

wherein

said opinion information selection part selects one or more pieces of said primary opinion information based on user information acquired by said user information acquisition part.

[Additional Statement 16]

The information-processing device according to Additional statement 15, further comprising

an group determination part configured to determine, based on user information acquired by said user information acquisition part, a group to which said subject user belongs from among a plurality of groups,

wherein

said opinion information selection part selects one or more pieces of said primary opinion information based on said group to which said subject user belongs.

[Additional Statement 17]

The information-processing device according to Additional statement 16, further comprising:

an evaluation value conversion information storage part configured to store a correspondence relation between at least either of user's content of opinion with respect to one or more evaluation subjects and/or an input record of said content of opinion by a user and an evaluation value;

an evaluation value calculation part configured to convert, based on said correspondence relation stored by said evaluation value conversion information storage part, content of opinion indicated by said primary opinion information acquired by said opinion information acquisition part into an evaluation value,

wherein

said group determination part classifies each user into a plurality of groups in accordance with an input experience degree of said content of opinion, and determines a group to which said subject user belongs from among said plurality of groups based on user information acquired by said user information acquisition part, and

said opinion information selection part, based on said group to which said subject user belongs, selects preferentially said primary opinion information of which said evaluation value is small or said primary opinion information of which said evaluation value is large.

[Additional Statement 18]

The information-processing device according to Additional statement 16, further comprising:

an evaluation value conversion information storage part configured to store a correspondence relation between at least either of user's content of opinion with respect to one or more evaluation subjects and/or an input record of said content of opinion by a user and an evaluation value;

an evaluation value calculation part configured to convert, based on said correspondence relation stored by said evaluation value conversion information storage part and said group to which said subject user belongs, content of opinion indicated by said primary opinion information acquired by said opinion information acquisition part into an evaluation value,

wherein

said opinion information selection part selects one or more pieces of said primary opinion information based on an evaluation value converted by said evaluation value calculation part and said group to which said subject user belongs.

[Additional Statement 19]

The information-processing device according to Additional statement 16, further comprising

an evaluation value calculation part configured to calculate an expressivity indicating an affirmation expression degree and negative expression degree of said primary opinion information acquired by said opinion information acquisition part,

wherein

said opinion information selection part, based on said group to which said subject user belongs, selects preferentially said primary opinion information of which said expressivity is small or said primary opinion information of which said expressivity is large.

[Additional Statement 20]

The information-processing device according to any of Additional statements 1 to 19, further comprising

an input record information acquisition part configured to acquire input record information indicating a record where each user has inputted content of opinion with respect to said primary opinion information,

wherein

said opinion information selection part selects one or more pieces of said primary opinion information based on said input record information acquired by said input record information acquisition part.

[Additional Statement 21]

The information-processing device according to Additional statement 20, wherein

said opinion information selection part, from among a plurality of pieces of said primary opinion information acquired by said opinion information acquisition part, selects one or more pieces of said primary opinion information based on content of opinion indicated by said primary opinion information, and from among selected said primary opinion information, selects one or more pieces of said primary opinion information as said input-prompting information based on said input record information.

[Additional Statement 22]

The information-processing device according to any of Additional statements 1 to 21, wherein

said opinion information acquisition part, further, acquires secondary opinion information indicating each user's content of opinion with respect to said primary opinion information, and

said opinion information selection part selects one or more pieces of said primary opinion information based on content of opinion indicated by said secondary opinion information.

[Additional Statement 23]

The information-processing device according to Additional statement 22, wherein

said opinion information selection part, from among a plurality of pieces of said primary opinion information acquired by said opinion information acquisition part, selects one or more said pieces of said primary opinion information based on content of opinion indicated by said primary opinion information, and from among said selected primary opinion information, selects one or more pieces of said primary opinion information as said input-prompting information based on content of opinion indicated by said secondary opinion information.

[Additional Statement 24]

The information-processing device according to any of Additional statements 1 to 23, further comprising

an input record information acquisition part configured to acquire input record information indicating a record where each user has inputted content of opinion with respect to said presented evaluation subject,

wherein

said opinion information presentation, based on said input record information acquired by said input record information acquisition part, determines a presenting method of one or more pieces of said primary opinion information selected by said opinion information selection part.

[Additional Statement 25]

The information-processing device according to Additional statement 24, wherein

said opinion information presentation part, based on said input record information acquired by said input record information acquisition part, determines a presenting timing of one or more pieces of said primary opinion information selected by said opinion information selection part.

[Additional Statement 26]

The information-processing device according to any of Additional statements 1 to 25, wherein

said opinion information presentation part presents said input-prompting information to said subject user in the case where content of opinion with respect to said presented evaluation subject is not inputted even if a prescribed time has elapsed after the prescribed timing.

[Additional Statement 27]

The information-processing device according to Additional statement 26, further comprising

an input record information acquisition part configured to acquire standby time after said prescribed timing until each user starts inputting of content of opinion with respect to said presented evaluation subject, wherein

said opinion information presentation part calculates said prescribed time based on each said standby time acquired by said input record information acquisition part.

[Additional Statement 28]

The information-processing device according to Additional statement 27, wherein

said opinion information presentation part calculates a mean time of each said standby time acquired by said input record information acquisition part, and calculates time shorter than calculated said mean time as said prescribed time.

[Additional Statement 29]

The information-processing device according to Additional statement 27, wherein

said opinion information presentation part creates a frequency distribution of each said standby time acquired by said input record information acquisition part, and detects a peak in a created frequency distribution, and calculates time shorter than said standby time corresponding to a detected peak as said prescribed time.

[Additional Statement 30]

The information-processing device according to Additional statement 29, further comprising

a user information acquisition part configured to acquire user information indicating standby time after said prescribed timing until said subject user starts inputting of content of opinion with respect to one or more evaluation subjects,

wherein

said opinion information presentation part, in the case of detecting a plurality of peaks in said created frequency distribution, based on user information acquired by said user information acquisition part 7, creates a frequency distribution of each said standby time of said subject user, and selects any of said plurality of peaks based on created said subject user's frequency distribution, and calculates time shorter than said standby time corresponding to a selected peak as said prescribed time.

[Additional Statement 31]

A comment-prompting method comprising:

a step to acquire primary opinion information indicating each user's content of opinion with respect to one or more evaluation subjects;

a step to select one or more pieces of said primary opinion information, as input-prompting information for the purpose of prompting a subject user to input content of opinion with respect to a presented evaluation subject which is a evaluation subject presented to said subject user from among acquired two or more pieces of said primary opinion information; and

a step to present selected one or more pieces of said primary opinion information to said subject user.

[Additional Statement 32]

The comment-prompting method according to Additional statement 31, wherein

said primary opinion information is textual information, and

said comment-prompting method further comprises

a step to convert, based on a correspondence relation between textual information characteristics and an evaluation value, content of opinion indicated by acquired said primary opinion information into an evaluation value, wherein

in a step to select said primary opinion information, one or more pieces of said primary opinion information are selected based on a converted evaluation value.

[Additional Statement 33]

The comment-prompting method according to Additional statement 32, wherein

in said correspondence relation, a plurality of ranges are provided with respect to a degree of said textual information characteristics, and an evaluation value for every said range is indicated.

[Additional Statement 34]

The comment-prompting method according to Additional statement 32 or 33, wherein

in said correspondence relation, the nearer the number of characters of said primary opinion information approaches to a prescribed value, the larger an evaluation value is.

[Additional Statement 35]

The comment-prompting method according to any of Additional statements 32 to 34, wherein

in said correspondence relation, the nearer a content percentage of Hiragana in said primary opinion information approaches to a prescribed value, the larger an evaluation value is.

[Additional Statement 36]

The comment-prompting method according to any of Additional statements 32 to 35, wherein

in said correspondence relation, the nearer a content percentage of Chinese character in said primary opinion information approaches to a prescribed value, the larger an evaluation value is.

[Additional Statement 37]

The comment-prompting method according to any of Additional statements 32 to 36, wherein

in said correspondence relation, the nearer the number of emotional expression words or emotional expression symbols in said primary opinion information approaches to a prescribed value, the larger an evaluation value is.

[Additional Statement 38]

The comment-prompting method according to any of Additional statements 31 to 35, wherein

said primary opinion information is textual information, and

in a step to select said primary opinion information, selected are one or more pieces of said primary opinion information based on at least one of the number of characters, a content percentage of Hiragana, a content percentage of Chinese character, the number of prescribed terms, the number of prescribed words, and the number of prescribed symbols, in said primary opinion information.

[Additional Statement 39]

The comment-prompting method according to any of Additional statements 31 to 38, further comprising

a step to acquire input record information indicating a record where each user has inputted content of opinion with respect to one or more evaluation subjects,

wherein

in a step to select said primary opinion information, selected are one or more pieces of said primary opinion information based on acquired said input record information.

[Additional Statement 40]

The comment-prompting method according to Additional statement 39, further comprising

a step to convert, based on a correspondence relation between an input record of said content of opinion by a user and an evaluation value, said input record information corresponding to acquired said primary opinion information into an evaluation value,

wherein

in a step to select said primary opinion information, selected are one or more pieces of said primary opinion information based on a converted evaluation value.

[Additional Statement 41]

The comment-prompting method according to Additional statement 40, wherein

in said correspondence relation, the shorter an input time of said content of opinion by a user is, the larger an evaluation value is.

[Additional Statement 42]

The comment-prompting method according to any of Additional statements 31 to 41, further comprising:

a step to select, as input-prompting information for the purpose of prompting said subject user to input content of opinion with respect to said presented evaluation subject, from among one or more prescribed messages, one or more said messages; and

a step to present selected one or more said messages to said subject user.

[Additional Statement 43]

The comment-prompting method according to Additional statement 42, wherein

in a step to select said message, based on content of opinion indicated by said primary opinion information, selected are one or more said messages.

[Additional Statement 44]

The comment-prompting method according to Additional statement 43, wherein

in a step to present said message, in place of presenting said primary opinion information in a step to present said primary opinion information, presented are one or more said messages to said subject user.

[Additional Statement 45]

The comment-prompting method according to any of Additional statements 31 to 44, further comprising

a step to acquire user information indicating at least either of said subject user's content of opinion with respect to one or more evaluation subjects and/or a record in which said subject user has inputted said content of opinion, wherein

in a step to select said primary opinion information, selected are one or more pieces of said primary opinion information based on acquired said user information.

[Additional Statement 46]

The comment-prompting method according to Additional statement 45, further comprising

a step to determine a group to which said subject user belongs from among a plurality of groups based on said acquired user information, wherein

in a step to select said primary opinion information, selected are one or more pieces of said primary opinion information based on said group to which said subject user belongs.

[Additional Statement 47]

The comment-prompting method according to Additional statement 46, further comprising

a step to convert, based on a correspondence relation between at least either of user's content of opinion with respect to one or more evaluation subjects and/or an input record of said content of opinion by a user and an evaluation value, content of opinion indicated by acquired said primary opinion information into an evaluation value,

wherein

in a step to determine said group, classified is each user into a plurality of groups in accordance with an input experience degree of said content of opinion, and determined is a group to which said subject user belongs from among said plurality of groups based on acquired said user information, and

in a step to select said primary opinion information, based on said group to which said subject user belongs, selected preferentially is said primary opinion information of which said evaluation value is small or said primary opinion information of which said evaluation value is large.

[Additional Statement 48]

The comment-prompting method according to Additional statement 46, further comprising

a step to convert, based on a correspondence relation between at least either of user's content of opinion with respect to one or more evaluation subjects and/or an input record of said content of opinion by a user and an evaluation value and on said group to which said subject user belongs, content of opinion indicated by acquired said primary opinion information into an evaluation value,

wherein

in a step to select said primary opinion information, selected are one or more pieces of said primary opinion information based on converted evaluation value and said group to which said subject user belongs.

[Additional Statement 49]

The comment-prompting method according to Additional statement 46, further comprising

a step to calculate an expressivity indicating an affirmation expression degree and negative expression degree of said acquired primary opinion information,

wherein

in a step to select said primary opinion information, based on said group to which said subject user belongs, selected preferentially is said primary opinion information of which said expressivity is small or said primary opinion information of which said expressivity is large.

[Additional Statement 50]

The comment-prompting method according to any of Additional statements 31 to 49, further comprising

a step to acquire input record information indicating a record where each user has inputted content of opinion with respect to said primary opinion information,

wherein

in a step to select said primary opinion information, selected are one or more pieces of said primary opinion information based on acquired said input record information.

[Additional Statement 51]

The comment-prompting method according to Additional statement 50, wherein

in a step to select said primary opinion information, from among acquired two or more said primary opinion information, selected are one or more said pieces of said primary opinion information based on content of opinion indicated by said primary opinion information, and from among selected said primary opinion information, one or more pieces of said primary opinion information are selected as said input-prompting information based on said input record information.

[Additional Statement 52]

The comment-prompting method according to any of Additional statements 31 to 51, wherein

in a step to acquire said primary opinion information, further, acquired is secondary opinion information indicating each user' content of opinion with respect to said primary opinion information, and

in a step to select said primary opinion information, selected are one or more pieces of said primary opinion information based on content of opinion indicated by said secondary opinion information.

[Additional Statement 53]

The comment-prompting method according to Additional statement 52, wherein

in a step to select said primary opinion information, from among acquired two or more pieces of said primary opinion information, selected are one or more pieces of said primary opinion information based on content of opinion indicated by said primary opinion information, and from among selected said primary opinion information, selected are one or more pieces of said primary opinion information as said input-prompting information based on content of opinion indicated by said secondary opinion information.

[Additional Statement 54]

The comment-prompting method according to any of Additional statements 31 to 53, further comprising

a step to acquire input record information indicating a record where each user has inputted content of opinion with respect to said presented evaluation subject,

wherein

in a step to present said primary opinion information, based on acquired said input record information, determined is a presenting method of selected one or more pieces of said selected primary opinion information.

[Additional Statement 55]

The comment-prompting method according to Additional statement 54, wherein

in a step to present said primary opinion information, determined is a presenting timing of selected one or more pieces of said primary opinion information based on acquired said input record information.

[Additional Statement 56]

The comment-prompting method according to any of Additional statements 31 to 55, wherein

in a step to present said primary opinion information, presented is said input-prompting information to said subject user in the case where content of opinion with respect to said presented evaluation subject is not inputted even if a prescribed time has elapsed after a prescribed timing.

[Additional Statement 57]

A comment-prompting method according to Additional statement 56, further comprising

a step to acquire standby time after said prescribed timing until each user starts inputting of content of opinion with respect to said presented evaluation subject,

wherein

in a step to present said primary opinion information, calculated is said prescribed time based on acquired each said standby time.

[Additional Statement 58]

The comment-prompting method according to Additional statement 57, wherein

in a step to present said primary opinion information, calculated is mean time of acquired each said standby time, and calculated is time shorter than calculated said mean time as said prescribed time.

[Additional Statement 59]

A comment-prompting method according to Additional statement 57, wherein

in a step to present said primary opinion information, created is a frequency distribution of acquired each said standby time, and detected is a peak in a created frequency distribution, and calculated is time shorter than said standby time corresponding to a detected peak as said prescribed time.

[Additional Statement 60]

A comment-prompting method according to Additional statement 59, further comprising

a step to acquire user information indicating stand by time after said prescribed timing until said subject user starts inputting of content of opinion with respect to one or more evaluation subjects,

wherein

in a step to present said primary opinion information, in the case of detecting a plurality of peaks in said frequency distribution, based on acquired said user information, created is a frequency distribution of each said standby time of said subject user, and selected is any of said two or more peaks based on created said subject user's frequency distribution, and calculated is time shorter than said standby time corresponding to a selected peak as said prescribed time.

[Additional Statement 61]

A computer readable recording medium in which a comment-prompting program is recorded, said comment-prompting program being a program configured to make a computer execute the steps of:

acquiring primary opinion information indicating each user's content of opinion with respect to one or more evaluation subjects;

selecting one or more pieces of said primary opinion information, from among acquired two or more pieces of said primary opinion information, as input-prompting information for the purpose of prompting a subject user to input content of opinion with respect to a presented evaluation subject which is a evaluation subject presented to said subject user; and

presenting selected one or more pieces of said primary opinion information to said subject user.

[Additional Statement 62]

The computer readable recording medium according to Additional statement 61, wherein

said primary opinion information is textual information, and

said comment-prompting program, further, is a program configured to make a computer execute a step to convert content of opinion indicated by acquired said primary opinion information into an evaluation value based on a correspondence relation between textual information characteristics and an evaluation value, and

in a step to select said primary opinion information, selected are one or more pieces of said primary opinion information based on an converted evaluation value.

[Additional Statement 63]

The computer readable recording medium according to Additional statement 62, wherein

in said correspondence relation, a plurality of ranges are provided with respect to a degree of said textual information characteristics, and an evaluation value for every said range is indicated.

[Additional Statement 64]

The computer readable recording medium according to Additional statement 62 or 63, wherein

in said correspondence relation, the nearer the number of characters of said primary opinion information approaches to a prescribed value, the larger an evaluation value is.

[Additional Statement 65]

The computer readable recording medium according to any of Additional statements 62 to 64, wherein

in said correspondence relation, the nearer a content percentage of Hiragana in said primary opinion information approaches to a prescribed value, the larger an evaluation value is.

[Additional Statement 66]

The computer readable recording medium according to any of Additional statements 62 to 65, wherein

in said correspondence relation, the nearer a content percentage of Chinese character in said primary opinion information approaches to a prescribed value, the larger an evaluation value is.

[Additional Statement 67]

The computer readable recording medium according to any of Additional statements 62 to 66, wherein

in said correspondence relation, the nearer the number of emotional expression words or emotional expression symbols in said primary opinion information approaches to a prescribed value, the larger an evaluation value is.

[Additional Statement 68]

The computer readable recording medium according to any of Additional statements 61 to 65, wherein

said primary opinion information is textual information, and

in a step to select said primary opinion information, selected are one or more pieces of said primary opinion information based on at least one of the number of characters, a content percentage of Hiragana, a content percentage of Chinese character, the number of prescribed terms, the number of prescribed words, and the number of prescribed symbols, in said primary opinion information.

[Additional Statement 69]

The computer readable recording medium according to any of Additional statements 61 to 68, said comment-prompting program being a program configured to make a computer further execute the step of:

acquiring input record information indicating a record where each user has inputted content of opinion with respect to one or more evaluation subjects, wherein

in a step to select said primary opinion information, selected are one or more pieces of said primary opinion information based on acquired said input record information.

[Additional Statement 70]

The computer readable recording medium according to Additional statement 69, said comment-prompting program being a program configured to make a computer further execute the step of:

converting, based on a correspondence relation between an input record of said content of opinion by a user and an evaluation value, said input record information corresponding to acquired said primary opinion information into an evaluation value,

wherein

in a step to select said primary opinion information, selected are one or more pieces of said primary opinion information based on a converted evaluation value.

[Additional Statement 71]

The computer readable recording medium according to Additional statement 70, wherein

in said correspondence relation, the shorter an input time of said content of opinion by a user is, the larger an evaluation value is.

[Additional Statement 72]

The computer readable recording medium according to any of Additional statements 61 to 71, said comment-prompting program being a program configured to make a computer further execute the steps of:

selecting, as input-prompting information for the purpose of prompting said subject user to input content of opinion with respect to said presented evaluation subject, from among one or more prescribed messages, one or more said messages; and

presenting selected one or more said messages to said subject user.

[Additional Statement 73]

The computer readable recording medium according to Additional statement 72, wherein

in a step to select said message, based on content of opinion indicated by said primary opinion information, selected are one or more said messages.

[Additional Statement 74]

The computer readable recording medium according to Additional statement 73, wherein

in a step to present said message, in place of presenting said primary opinion information in a step to present said primary opinion information, presented are one or more said messages to said subject user.

[Additional Statement 75]

The computer readable recording medium according to any of Additional statements 61 to 74, said comment-prompting program being a program configured to make a computer further execute the steps of:

acquiring user information indicating at least either of said subject user's content of opinion with respect to one or more evaluation subjects and/or a record in which said subject user has inputted said content of opinion, wherein

selecting said primary opinion information, selected are one or more pieces of said primary opinion information based on acquired said user information.

[Additional Statement 76]

The computer readable recording medium according to Additional statement 75, said comment-prompting program being a program configured to make a computer further execute the steps of:

determining a group to which said subject user belongs from among a plurality of groups based on said acquired user information, wherein

selecting said primary opinion information, selected are one or more pieces of said primary opinion information based on said group to which said subject user belongs.

[Additional Statement 77]

The computer readable recording medium according to Additional statement 76, said comment-prompting program being a program configured to make a computer further execute the steps of:

converting, based on a correspondence relation between at least either of user's content of opinion with respect to one or more evaluation subjects and/or an input record of said content of opinion by a user and an evaluation value, content of opinion indicated by acquired said primary opinion information into an evaluation value,

wherein

determining said group, classified is each user into a plurality of groups in accordance with an input experience degree of said content of opinion, and determined is a group to which said subject user belongs from among said plurality of groups based on acquired said user information, and

selecting said primary opinion information, based on said group to which said subject user belongs, selected preferentially is said primary opinion information of which said evaluation value is small or said primary opinion information of which said evaluation value is large.

[Additional Statement 78]

The computer readable recording medium according to Additional statement 76, said comment-prompting program being a program configured to make a computer further execute the step of:

converting, based on a correspondence relation between at least either of user's content of opinion with respect to one or more evaluation subjects and/or an input record of said content of opinion by a user and an evaluation value and on said group to which said subject user belongs, content of opinion indicated by acquired said primary opinion information into an evaluation value,

wherein

in a step to select said primary opinion information, selected are one or more pieces of said primary opinion information based on converted evaluation value and said group to which said subject user belongs.

[Additional Statement 79]

The computer readable recording medium according to Additional statement 76, said comment-prompting program being a program configured to make a computer further execute the step of:

calculating an expressivity indicating an affirmation expression degree and negative expression degree of said acquired primary opinion information,

wherein

in a step to select said primary opinion information, based on said group to which said subject user belongs, selected preferentially is said primary opinion information of which said expressivity is small or said primary opinion information of which said expressivity is large.

[Additional Statement 80]

The computer readable recording medium according to any of Additional statements 61 to 79, said comment-prompting program being a program configured to make a computer further execute the step of:

acquiring input record information indicating a record where each user has inputted content of opinion with respect to said primary opinion information, wherein

in a step to select said primary opinion information, selected are one or more pieces of said primary opinion information based on acquired said input record information.

[Additional Statement 81]

The computer readable recording medium according to Additional statement 80, wherein

in a step to select said primary opinion information, from among acquired two or more said primary opinion information, selected are one or more said pieces of said primary opinion information based on content of opinion indicated by said primary opinion information, and from among selected said primary opinion information, one or more pieces of said primary opinion information are selected as said input-prompting information based on said input record information.

[Additional Statement 82]

The computer readable recording medium according to any of Additional statements 61 to 81, wherein

in a step to acquire said primary opinion information, further, acquired is secondary opinion information indicating each user' content of opinion with respect to said primary opinion information, and

in a step to select said primary opinion information, selected are one or more pieces of said primary opinion information based on content of opinion indicated by said secondary opinion information.

[Additional Statement 83]

The computer readable recording medium according to Additional statement 82, wherein

in a step to select said primary opinion information, from among acquired two or more pieces of said primary opinion information, selected are one or more pieces of said primary opinion information based on content of opinion indicated by said primary opinion information, and from among selected said primary opinion information, selected are one or more pieces of said primary opinion information as said input-prompting information based on content of opinion indicated by said secondary opinion information.

[Additional Statement 84]

The computer readable recording medium according to any of Additional statements 61 to 83, said comment-prompting program being a program configured to make a computer further execute the step of:

acquiring input record information indicating a record where each user has inputted content of opinion with respect to said presented evaluation subject, wherein

in a step to present said primary opinion information, based on acquired said input record information, determined is a presenting method of selected one or more pieces of said selected primary opinion information.

[Additional Statement 85]

The computer readable recording medium according to Additional statement 84, wherein

in a step to present said primary opinion information, determined is a presenting timing of selected one or more pieces of said primary opinion information based on acquired said input record information.

[Additional Statement 86]

The computer readable recording medium according to any of Additional statements 61 to 85, wherein

in a step to present said primary opinion information, presented is said input-prompting information to said subject user in the case where content of opinion with respect to said presented evaluation subject is not inputted even if a prescribed time has elapsed after a prescribed timing.

[Additional Statement 87]

A computer readable recording medium according to Additional statement 86, said comment-prompting program being a program configured to make a computer further execute the step of:

acquiring standby time after said prescribed timing until each user starts inputting of content of opinion with respect to said presented evaluation subject, wherein

in a step to present said primary opinion information, calculated is said prescribed time based on acquired each said standby time.

[Additional Statement 88]

The computer readable recording medium according to Additional statement 87, wherein

in a step to present said primary opinion information, calculated is mean time of acquired each said standby time, and calculated is time shorter than calculated said mean time as said prescribed time.

[Additional Statement 89]

A computer readable recording medium according to Additional statement 87, wherein

in a step to present said primary opinion information, created is a frequency distribution of acquired each said standby time, and detected is a peak in a created frequency distribution, and calculated is time shorter than said standby time corresponding to a detected peak as said prescribed time.

[Additional Statement 90]

A computer readable recording medium according to Additional statement 89, said comment-prompting program being a program configured to make a computer further execute the step of:

acquiring user information indicating standby time after said prescribed timing until said subject user starts inputting of content of opinion with respect to one or more evaluation subjects,

wherein

in a step to present said primary opinion information, in the case of detecting a plurality of peaks in said frequency distribution, based on acquired said user information, created is a frequency distribution of each said standby time of said subject user, and selected is any of said two or more peaks based on created said subject user's frequency distribution, and calculated is time shorter than said standby time corresponding to a selected peak as said prescribed time.

Above-mentioned embodiments should be considered to an exemplification at all points, and not restrictive. The scope of the present invention is shown not by descriptions mentioned above but by the scope of the claims, and all modifications within meaning and scope equivalent to the claims are intended to be included therein.

This application claims priority on the basis of Japanese Patent Application No. 2010-238242 applied on Oct. 25, 2010, and takes in here all the disclosures thereof.

### INDUSTRIAL APPLICABILITY

According to the present invention, in a system for the purpose of collecting opinions with respect to a certain content, it is possible to induce a large number of users' comments. Therefore, the present invention has industrial applicability.

### DESCRIPTION OF SYMBOLS

1 Opinion Information Acquisition Part
2 Opinion Information Selection Part
3 Opinion Information Presentation Part
4 Input Record Information Acquisition Part
5 Evaluation Value Conversion Information Storage Part
7 User Information Acquisition Part
8 Group Determination Part
9 Message Storage Part
10 Message Selecting Part
11 Message Presenting Part
12 Evaluation Value Calculation Part
13 Evaluation Value Storage Part
14 Opinion Information Storage Part
15 Input Record Information Storage Part
16 User Information Storage Part
101 Cpu
102 Main Memory
103 Hard Disk
104 Input Interface
105 Display Controller
106 Data Reader/Writer
107 Communication Interface
108 Keyboard
109 Mouse
110 Display
111 Recording Medium
121 Bus
201,202,203,204 Information-Processing Device

What is claimed is:

1. An information-processing device, comprising:
an opinion information acquisition part configured to acquire primary opinion information indicating each user's content of opinion with respect to one or more evaluation subjects;
an opinion information selection part configured to select one or more pieces of said primary opinion information, as input-prompting information for the purpose of prompting a subject user to input content of opinion with respect to a presented evaluation subject which is a evaluation subject presented to said subject user from among a plurality of pieces of said primary opinion information acquired by said opinion information acquisition part; and
an opinion information presentation part configured to present, to said subject user, one or more pieces of said primary opinion information selected by said opinion information selection part.

2. The information-processing device according to claim 1, wherein
said primary opinion information is textual information, and
said information-processing device further comprises:
an evaluation value conversion information storage part configured to store a correspondence relation between textual information characteristics and a evaluation value; and
an evaluation value calculation part configured to convert, based on said correspondence relation stored by said evaluation value conversion information storage part, content of opinion indicated by said primary opinion information acquired by said opinion information acquisition part into an evaluation value,
wherein
said opinion information selection part selects one or more pieces of said primary opinion information based on an evaluation value converted by said evaluation value calculation part.

3. The information-processing device according to claim 2, wherein
said evaluation value conversion information storage part is provided with a plurality of ranges with respect to a degree of said textual information characteristics, and stores said correspondence relation indicating an evaluation value for every said range.

4. The information-processing device according to claim 2, wherein
said evaluation value conversion information storage part stores said correspondence relation in which the nearer the number of characters of said primary opinion information approaches to a prescribed value, the larger an evaluation value is.

5. The information-processing device according to claim 2, wherein
said evaluation value conversion information storage part stores said correspondence relation in which the nearer a content percentage of Hiragana in said primary opinion information approaches to a prescribed value, the larger an evaluation value is.

6. The information-processing device according to claim 2, wherein
said evaluation value conversion information storage part stores said correspondence relation in which the nearer a content percentage of Chinese character in said primary opinion information approaches to a prescribed value, the larger an evaluation value is.

7. The information-processing device according to claim 2, wherein
said evaluation value conversion information storage part stores said correspondence relation in which the nearer the number of emotional expression words or emotional expression symbols in said primary opinion information approaches to a prescribed value, the larger an evaluation value is.

8. The information-processing device according to claim 1, wherein
said primary opinion information is textual information, and
said opinion information selection part selects one or more pieces of said primary opinion information based on at least one of the number of characters, a content percentage of Hiragana, a content percentage of Chinese character, the number of prescribed terms, the number of prescribed words, and the number of prescribed symbols, in said primary opinion information.

9. The information-processing device according to claim 1, further comprising
an input record information acquisition part configured to acquire input record information indicating a record where each user has inputted content of opinion with respect to one or more evaluation subjects,
wherein
said opinion information selection part selects one or more pieces of said primary opinion information based on said input record information acquired by said input record information acquisition part.

10. The information-processing device according to claim 9, further comprising:
an evaluation value conversion information storage part configured to store a correspondence relation between an input record of said content of opinion by a user and an evaluation value; and
an evaluation value calculation part configured to convert, based on said correspondence relation stored by said evaluation value conversion information storage part, said input record information corresponding to said primary opinion information acquired by said opinion information acquisition part into an evaluation value,
wherein
said opinion information selection part selects one or more pieces of said primary opinion information based on an evaluation value converted by said evaluation value calculation part.

11. The information-processing device according to claim 10, wherein
said evaluation value conversion information storage part stores said correspondence relation in which the shorter an input time of said content of opinion by a user is, the larger an evaluation value is.

12. The information-processing device according to claim 1, further comprising:
a message storage part configured to store one or more prescribed messages;
a message selecting part configured to select one or more said messages, as input-prompting information for the purpose of prompting said subject user to input content of opinion with respect to said presented evaluation subject, from among one or more said messages stored by said message storage part; and
a message presenting part configured to present one or more said messages selected by said message selecting part to said subject user.

13. The information-processing device according to claim 12, wherein
said message selecting part, based on content of opinion indicated by one or more pieces of said primary opinion information selected by said opinion information selection part, selects one or more said messages.

14. The information-processing device according to claim 13, wherein
said message presenting part, in place of said opinion information presentation part presenting said primary opinion information, presents one or more said messages to said subject user.

15. The information-processing device according to claim 1, further comprising
a user information acquisition part configured to acquire user information indicating at least any of said subject user's content of opinion with respect to one or more evaluation subjects and a record in which said subject user has inputted said content of opinion,
wherein
said opinion information selection part selects one or more pieces of said primary opinion information based on user information acquired by said user information acquisition part.

16. The information-processing device according to claim 15, further comprising
an group determination part configured to determine, based on user information acquired by said user information acquisition part, a group to which said subject user belongs from among a plurality of groups,
wherein
said opinion information selection part selects one or more pieces of said primary opinion information based on said group to which said subject user belongs.

17. The information-processing device according to claim 16, further comprising:
an evaluation value conversion information storage part configured to store a correspondence relation between at least either of user's content of opinion with respect to one or more evaluation subjects and/or an input record of said content of opinion by a user and an evaluation value;
an evaluation value calculation part configured to convert, based on said correspondence relation stored by said evaluation value conversion information storage part, content of opinion indicated by said primary opinion information acquired by said opinion information acquisition part into an evaluation value,
wherein
said group determination part classifies each user into a plurality of groups in accordance with an input experience degree of said content of opinion, and determines a group to which said subject user belongs from among said plurality of groups based on user information acquired by said user information acquisition part, and
said opinion information selection part, based on said group to which said subject user belongs, selects preferentially said primary opinion information of which said evaluation value is small or said primary opinion information of which said evaluation value is large.

18. The information-processing device according to claim 16, further comprising:
an evaluation value conversion information storage part configured to store a correspondence relation between at least either of user's content of opinion with respect to one or more evaluation subjects and/or an input record of said content of opinion by a user and an evaluation value;
an evaluation value calculation part configured to convert, based on said correspondence relation stored by said evaluation value conversion information storage part and said group to which said subject user belongs, content of opinion indicated by said primary opinion information acquired by said opinion information acquisition part into an evaluation value,
wherein
said opinion information selection part selects one or more pieces of said primary opinion information based on an evaluation value converted by said evaluation value calculation part and said group to which said subject user belongs.

19. The information-processing device according to claim 16, further comprising
an evaluation value calculation part configured to calculate an expressivity indicating an affirmation expression degree and negative expression degree of said primary opinion information acquired by said opinion information acquisition part,
wherein
said opinion information selection part, based on said group to which said subject user belongs, selects preferentially said primary opinion information of which said expressivity is small or said primary opinion information of which said expressivity is large.

20. The information-processing device according to claim 1, further comprising
an input record information acquisition part configured to acquire input record information indicating a record where each user has inputted content of opinion with respect to said primary opinion information,
wherein
said opinion information selection part selects one or more pieces of said primary opinion information based on said input record information acquired by said input record information acquisition part.

21. The information-processing device according to claim 20, wherein
said opinion information selection part, from among a plurality of pieces of said primary opinion information acquired by said opinion information acquisition part, selects one or more pieces of said primary opinion information based on content of opinion indicated by said primary opinion information, and from among selected said primary opinion information, selects one or more pieces of said primary opinion information as said input-prompting information based on said input record information.

22. The information-processing device according to claim 1, wherein
said opinion information acquisition part, further, acquires secondary opinion information indicating each user's content of opinion with respect to said primary opinion information, and
said opinion information selection part selects one or more pieces of said primary opinion information based on content of opinion indicated by said secondary opinion information.

23. The information-processing device according to claim 22, wherein
said opinion information selection part, from among a plurality of pieces of said primary opinion information acquired by said opinion information acquisition part, selects one or more said pieces of said primary opinion information based on content of opinion indicated by said primary opinion information, and from among said selected primary opinion information, selects one or more pieces of said primary opinion information as said input-prompting information based on content of opinion indicated by said secondary opinion information.

24. The information-processing device according to claim 1, further comprising
an input record information acquisition part configured to acquire input record information indicating a record where each user has inputted content of opinion with respect to said presented evaluation subject,
wherein
said opinion information presentation, based on said input record information acquired by said input record information acquisition part, determines a presenting method of one or more pieces of said primary opinion information selected by said opinion information selection part.

25. The information-processing device according to claim 24, wherein
said opinion information presentation part, based on said input record information acquired by said input record information acquisition part, determines a presenting timing of one or more pieces of said primary opinion information selected by said opinion information selection part.

26. The information-processing device according to claim 1, wherein
said opinion information presentation part presents said input-prompting information to said subject user in the case where content of opinion with respect to said presented evaluation subject is not inputted even if a prescribed time has elapsed after the prescribed timing.

27. The information-processing device according to claim 26, further comprising
an input record information acquisition part configured to acquire standby time after said prescribed timing until each user starts inputting of content of opinion with respect to said presented evaluation subject, wherein
said opinion information presentation part calculates said prescribed time based on each said standby time acquired by said input record information acquisition part.

28. The information-processing device according to claim 27, wherein
said opinion information presentation part calculates a mean time of each said standby time acquired by said input record information acquisition part, and calculates time shorter than calculated said mean time as said prescribed time.

29. The information-processing device according to claim 27, wherein
said opinion information presentation part creates a frequency distribution of each said standby time acquired by said input record information acquisition part, and detects a peak in a created frequency distribution, and calculates time shorter than said standby time corresponding to a detected peak as said prescribed time.

30. The information-processing device according to claim 29, further comprising
a user information acquisition part configured to acquire user information indicating standby time after said prescribed timing until said subject user starts inputting of content of opinion with respect to one or more evaluation subjects,
wherein
said opinion information presentation part, in the case of detecting a plurality of peaks in said created frequency distribution, based on user information acquired by said user information acquisition part 7, creates a frequency distribution of each said standby time of said subject user, and selects any of said plurality of peaks based on created said subject user's frequency distribution, and calculates time shorter than said standby time corresponding to a selected peak as said prescribed time.

31. A comment-prompting method comprising:
a step to acquire primary opinion information indicating each user's content of opinion with respect to one or more evaluation subjects;
a step to select one or more pieces of said primary opinion information, as input-prompting information for the purpose of prompting a subject user to input content of opinion with respect to a presented evaluation subject which is a evaluation subject presented to said subject user from among acquired two or more pieces of said primary opinion information; and
a step to present selected one or more pieces of said primary opinion information to said subject user.

32. A computer readable recording medium in which a comment-prompting program is recorded, said comment-prompting program being a program configured to make a computer execute the steps of:
acquiring primary opinion information indicating each user's content of opinion with respect to one or more evaluation subjects;
selecting one or more pieces of said primary opinion information, from among acquired two or more pieces of said primary opinion information, as input-prompting information for the purpose of prompting a subject user to input content of opinion with respect to a presented evaluation subject which is a evaluation subject presented to said subject user; and
presenting selected one or more pieces of said primary opinion information to said subject user.
